(19) United States
(12) Patent Application Publication
(10) Pub. No.: US 2026/0303551 A1
(43) Pub. Date: Oct. 1, 2026

(54) AI-ASSISTED MEETING PLATFORM

(71) Applicant: 8x8, Inc., Campbell, CA (US)

(72) Inventors: Emil IVOV, Campbell, CA (US); Jared Smith MICKELSON, Campbell, CA (US)

(21) Appl. No.: 19/635,421

(22) Filed: Mar. 31, 2026

Related U.S. Application Data
(60) Provisional application No. 63/781,212, filed on Mar. 31, 2025.

(51) Int. Cl. H04L 51/02; G06F 16/34; G10L 15/26; H04L 51/04

(52) U.S. Cl. CPC H04L 51/02; G06F 16/345; G10L 15/26; H04L 51/04

(57) ABSTRACT

One or more methods, device, and/or systems may address issues and/or provide approaches for real-time meeting statuses and related actions, automations, information, and artificial intelligence enhancements.

### CROSS-REFERENCE TO RELATED APPLICATIONS

This application claims the benefit of U.S. Provisional Application No. 63/781,212, filed Mar. 31, 2025, the contents of which are incorporated herein by reference.

### BACKGROUND

The proliferation of digital communication and remote collaboration tools has significantly increased the volume of scheduled meetings in professional and enterprise environments. Modern meeting platforms and scheduling systems such as Microsoft Outlook and Google Calendar often result in users being double-booked or overwhelmed with overlapping meetings. While these platforms are effective in coordinating time and attendance, they lack intelligent mechanisms to prioritize, optimize, or personalize participation based on a user’s actual availability, role, or relevance to the meeting content.

### SUMMARY

One or more methods, device, and/or systems may address issues and/or provide approaches for real-time meeting statuses and related actions, automations, information, and artificial intelligence enhancements.

### BRIEF DESCRIPTION OF THE DRAWINGS

The following detailed description may be better understood in view of the figures, where like reference numerals in the figures indicate like elements, and wherein:

FIG. 1 illustrates an example of a computing device.

FIG. 2 illustrates an example of a network architecture of a communications system.

FIG. 3 illustrates an example of a graphical user interface (GUI) for upcoming meetings and past meetings.

FIG. 4 illustrates an example of a GUI for meeting settings.

FIG. 5 illustrates an example of a graphical user interface (GUI) of a live meeting session.

FIG. 6 illustrates an example of a graphical user interface (GUI) of a post-meeting interface.

FIG. 7 illustrates an example of an AI-enhanced virtual meeting system architecture.

FIG. 8A and FIG. 8B illustrates an example of an AI-enhanced meeting platform procedure.

### DETAILED DESCRIPTION OF EMBODIMENTS

In some situations, a person may have a large number of meetings scheduled in a meeting platform and/or scheduling system (e.g., outlook, Google Calendar, etc.), and in some instances, there may be double-booked meetings (e.g., two or more meetings at the same time, overlapping meetings, etc.). For a given invitee, or user, there may be specific questions or a need for a consensus from more than one person where a meeting (e.g., live virtual event with video, audio, or a phone call, etc.) with one or more other people is the most efficient means of achieving the desired goal (e.g., compared to another communication channel, such as email, slack, teams, etc.). Further, in such a situation, the user may need answers in a timely fashion, which is why simply rescheduling may not be the best option. As technology innovation increases, the speed at which business is conducted increases, and the likelihood of needing to attend or being needed to attend more than one meeting at a time increases.

This problem is inefficient for conducting business and inefficient from a computer processing perspective, since, in practice, attending more than one meeting at a time would require using more devices and/or additional processing resources.

One approach to address this would be to provide a user with a recording of a meeting that the person could not attend, but there may be additional problems with this approach, since then that person may have to execute a series of manual follow-ups with other users/departments, which is inefficient when the people with the answers were previously present at the missed meeting. Moreover, existing meeting platforms do not provide a mechanism for a user who cannot attend a meeting to indicate that the user still wishes to be part of the meeting's audience in a manner that is visible to other participants of the meeting and/or that triggers automatic delivery of meeting materials to the user. As a result, a user who is unable to attend may be treated identically to a user who has no interest in the meeting, and other participants in the meeting have no awareness of the absent user’s intentions to receive or act on information discussed during the meeting.

An approach to handling the problems described herein and others is needed. Meetings can be made more efficient by only requiring a given user’s attention at specific times, thereby reducing the time spent in meetings and enabling a more efficient usage of resources.

As described herein, one or more systems, methods, and/or devices may be used to optimize meeting efficiency. A meeting platform may use real-time or near real-time status, one or more users, and/or one or more bots/agents (e.g., as used herein, agent or bot may be interchangeable and may refer to an AI bot or AI agent that is representative of a large language model, machine learning, and/or the like).

At a high level, there may be a meeting platform where one or more users utilizing one or more devices (e.g., user equipment, computers, smartphones, etc.) may attend a meeting through a specific real-time communication channel hosted and organized by the meeting platform and/or with third-party integrations. A real-time communication channel may include, but is not limited to, one or more video meetings, audio-only meetings, phone calls, chat rooms, message threads, etc.

In one case, the meeting platform may be integrated into a larger software communications platform (e.g., unified communications, call center, etc.) (e.g., 8x8). Reference to the platform may refer to the meeting platform and/or the meeting platform incorporated into the communications platform and/or the communications platform, unless otherwise specified.

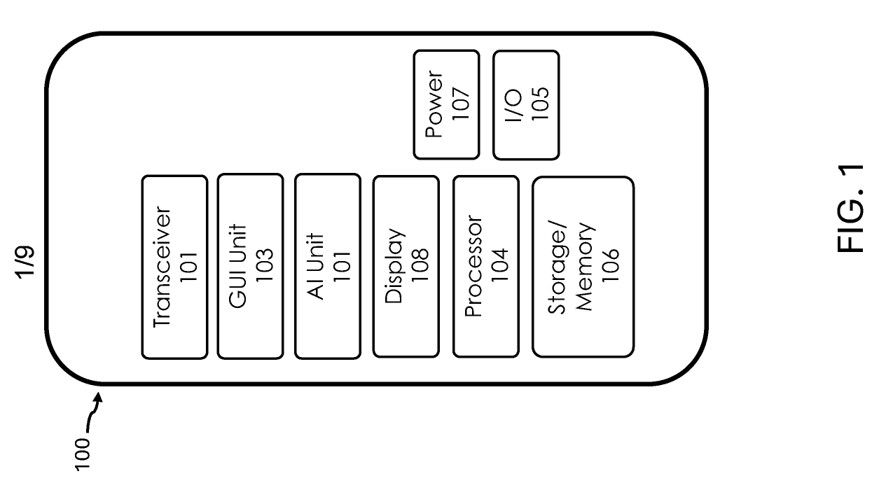

FIG. 1 is an example of a device. The device may take any form, such as a computer, server, a mobile device, networking equipment, communications equipment, phone switch, any device/functionality (e.g., as performed by an entity) described herein, or the like. As used herein, any reference to cloud computing, system computing, or any functionality may be performed on one or more computers. A computer 100 may be described in regard to components, units, and/or functionality that may be performed. A unit or component may represent hardware and/or software that perform a specific function alone or in conjunction with other units. A computer 100 may have one or more components, such as an AI processing unit 108, a wireless and/or wired transceiver unit 102, a GUI unit 103, a central processing unit 104, an I/O unit 105, a storage/memory unit 106, and/or a power unit 107. A computer 100 may have other hardware or software as is known in the art depending on the type of the device as disclosed herein (e.g., a smartphone may have a camera). For example, the computer may have input/output sensors (e.g., camera, microphone, keyboard, mouse, trackpad, etc.). For example, a computer 100 may run software/application (e.g., modules, etc.) 101 using the processor 104 (e.g., processor) operatively coupled to the storage/memory (e.g., RAM, hard drive, etc.) 106, the transceiver 102 (e.g., WIFI radio, cellular radio, networking interface, etc.), and a power component 107. In one example, a computer is a user equipment (UE) and sends a message to a communications platform (e.g., with a front end and a back end, where both the front end and back end each have one or more computers associated with it such that their respective functionalities may be performed); the UE may receive a response message from the communications platform, and display a GUI designed to receive commands and/or other user input into the UE. The commands/input may then be sent as a second message to the communications platform. This process may continue as needed (e.g., as described herein, according to one or more techniques, embodiments, examples, etc.).

A meeting may be conducted over a network between at least two devices via the meeting platform using one or more communication channels. The meeting platform may have one or more processing components configured/adapted to manage tasks associated with meeting optimization. For example, there may be a meeting manager component (e.g., associated with one or more servers) that performs one or more functions and is configured to interface with other processing components in an architecture of a software communications platform (e.g., 8x8 Work). In one example, additional sub-components may be configured for specific functionality (e.g., as described herein). Alternatively, individual management components may be configured for different functionalities.

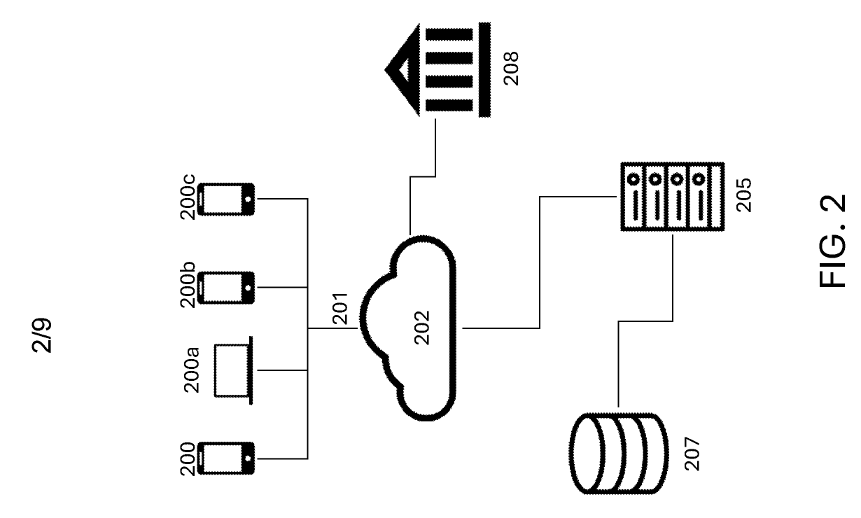

FIG. 2 illustrates an example of a network architecture of a communications network utilized by a meeting platform. The network may have one or more devices for users 200a-c that communicate 201 with a network 202 (e.g., Internet) in a wireless or wired manner. As an example, a user device 200 may be a user equipment (UE), a mobile station, a fixed or mobile subscriber unit, a pager, a cellular telephone, a personal digital assistant (PDA), a smartphone, a laptop, a netbook, a tablet, a personal computer, a wireless sensor, consumer electronics, a television, and the like. A UE 200 may be capable of receiving input and providing output to a user operating the UE 200. The UE 200 may also send and receive information through a local area network or the internet. The UE 200 may connect to the internet, which in turn may access a website/service/platform hosted by a server 205 (e.g., meeting platform) connected by a wired/wireless connection 203. The server 205 and database 207 may represent the infrastructure that facilitates one or more aspects of the meeting platform. In one configuration, the infrastructure may comprise a backend and frontend hosted through a self-hosted or remote-hosted service of several databases and/or servers protected by a firewall and accessed through a load balancer. The meeting platform may have elements that operate on cloud infrastructure such as Amazon® Web Services (AWS), Microsoft® Azure, or the like. The meeting platform may provide Software as a Service (SaaS) or Software as a Product (SaaP). The server 205 may provide service through a website/service/platform/application programming interface (API). The server 205 may be connected 206 to a database 207 that stores information related to input from any of the UEs 200, 200a-c. In an alternative configuration, there may be more than one database 207 and/or the database(s) may be part of server 205. The server 205 may also interact with a payment service 208 (e.g., where a user has paid for access to the meeting platform, etc.).

In one case (not shown in FIG. 2), there may be one or more components of the meeting platform. For example, there may be an AI management component (e.g., trained and adapted AI/ML Modeling) connected to or a part of the meeting platform that provides AI support and functionality. Additionally/alternatively, there may be a third-party vendor integration component, where one or more management components connect/integrate with the meeting platform to further extend functionality that may be provided by third-party vendors (e.g., CRM integration such as Salesforce, workforce management, PCI payment processing, chatbots, AI integrations (e.g., ChatGPT), and many more). Additionally/alternatively, there may be a GUI/UX component that has widgets, iframes, etc., built in to enable different functionalities and services provided in a comprehensive UI window. Additionally/alternatively, there may be breakout UI windows for different types of functionalities or a user-controlled ability to break out windows, arrange meeting optimization presentations in UI, etc. The GUI may have third-party integrations where UI windows display third-party integrations/functionality.

In one embodiment, an AI bot-assisted meeting platform may be realized as a multi-tier system that includes a front-end client application, a backend server, and a machine learning (ML) engine interconnected via a network. The platform may include a centralized server or cluster of servers that orchestrate the AI bot’s functions, such as speech recognition, natural language processing (“NLP”), and data retrieval from external databases. The front-end interface (e.g., a desktop application, mobile app, or web-based portal) enables meeting participants to interact with the AI bot during scheduling, agenda creation, and the meeting itself.

On initialization, the AI bot loads or retrieves user-profiles and meeting context data, which may be stored in a database or distributed across multiple data stores. The AI bot’s core intelligence resides in one or more NLP modules that process real-time audio or textual inputs during meetings. These modules tokenize and parse participant statements, identify relevant keywords (e.g., “financial update,” “sales pipeline,” “technical blocker”), and map them to recognized subject matter categories. The platform also employs a context inference engine that applies machine learning models (e.g., topic modeling, transformer-based language models) to glean the user’s intent and identify high-priority agenda items or outstanding action items.

The backend AI bot further comprises a recommendation engine configured to propose next steps or schedule follow-up sessions. Based on signals from the NLP modules and context inference engine, the recommendation engine evaluates factors such as project deadlines, user availability, and topic urgency. If the AI bot detects an unresolved topic requiring additional expertise, it queries a role-based directory or user profile data store to determine the most relevant stakeholders. The recommendation engine then notifies the meeting organizer (or the entire group) and, upon confirmation, proceeds to schedule a new session or add the new participant to the current session if permissible. In certain implementations, the system can automatically generate meeting invites, attach relevant documents, and update project management software.

To enhance the AI bot assisted meeting platform there may be dedicated integration modules that enable seamless data exchange with a variety of third-party systems, including but not limited to Customer Relationship Management (CRM) platforms (e.g., Salesforce), productivity suites (e.g., Google Workspace, Microsoft 365), and other enterprise software tools. Each integration module manages secure communication with a target third-party system via application programming interfaces (APIs), webhooks, or direct database connections. For instance, when the AI bot detects a request for a “sales performance update” during a meeting, the integration module corresponding to the CRM platform can authenticate the system’s credentials, query up-to-date sales pipeline information, and deliver the relevant metrics to the meeting participants in real time.

In one exemplary use case, upon receiving a user command such as “Provide the latest leads from Salesforce,” the AI bot’s NLP module interprets this request and triggers the Salesforce integration module. This module establishes a secure API session using OAuth or another authentication protocol, retrieves the requested lead data, and reformats it as needed (e.g., generating a concise table or visual chart). The reformatted information is then displayed within the meeting platform interface or shared as a link in the chat, allowing participants to collaboratively review and discuss the data without leaving the meeting environment.

Similarly, for calendar synchronization, the AI bot can integrate with Google Calendar or Microsoft Outlook via respective APIs to check user availability, propose meeting times, and automatically send out event invitations. The system may further leverage these integrations to attach pertinent documents—retrieved from Google Drive, Microsoft SharePoint, or other cloud storage solutions—to meeting events. The AI bot can also interface with task management platforms or product lifecycle management (PLM) tools so that any newly assigned action items are automatically logged with appropriate deadlines and assigned owners.

Moreover, the AI bot assisted meeting platform may be extensible, allowing administrators or developers to add additional integration modules for proprietary or custom enterprise systems. In such implementations, a standardized integration framework exposes hooks (e.g., RESTful endpoints or message bus channels) that can ingest and emit data according to the third-party system’s schema. This modular design ensures that the meeting platform remains adaptable and easily scalable as new integration requests or enterprise requirements arise.

To maintain data security and compliance, the platform may employ encryption protocols (e.g., TLS/SSL for in-transit data and AES for at-rest data) alongside fine-grained access controls. User permissions are typically managed through an identity and access management (IAM) layer, ensuring that only authorized entities and processes can retrieve or modify sensitive information from integrated systems. Any personal or confidential data handled by the AI bot is anonymized or masked where appropriate, while raw access logs may be retained for troubleshooting or audit purposes.

As used herein, the terms “simulated participant,” “AI bot,” “personal meeting bot,” “chatbot,” “virtual representative,” and similar terms may be used interchangeably to refer to a non-human, service-based, software-based, and/or AI-enabled meeting entity configured to participate in, observe, monitor, and/or otherwise interact with a meeting session on behalf of a user or other entity. Unless the context requires otherwise, these terms are not intended to denote different structures requiring separate treatment, but rather may describe the same or similar functionality in different embodiments, implementations, or usage contexts. Thus, reference to an “AI bot” in one example and a “simulated participant” in another example should be understood as referring to the same general class of meeting-related automated entity, whether the entity provides active interaction, passive monitoring, post-meeting processing support, or another meeting-related function described herein.

Generally, a meeting platform may manage, organize, and/or host meetings (e.g., where devices over a network can communicate in real time). The meeting platform may run on one or more computers, such as a server, or in cloud infrastructure. The meeting platform may have a front-end representation, such as an app installed on a computer or phone, a web interface, etc. The meeting platform may be integrated into a larger unified communication platform or call-center platform. The meeting platform may integrate with third-party communication channels and/or meeting programs. The meeting platform may provide a graphical user interface.

A meeting may be created on the meeting platform by one or more organizers. The one or more organizers who may invite, through the meeting platform or through a third party integration, one or more users to the meeting. The organizer may have authorization on the meeting platform to modify and/or cancel the meeting, while an invited user may not.

Each meeting may have an AI bot that may be representative of the meeting itself. For example, if the meeting’s purposes is to retrieve updates from different users in order to then plan out next steps live during the meeting, then the AI bot may “run” the meeting in so far as there may be an entity that is leading the conversation.

In some cases, each user of the meeting platform may have an account. The account may be associated with one or more devices. There may be categories or types of accounts that provide a unique set of features/functionalities. In one case, a user may be of a certain management level account, and the meeting platform may provide through an interface the ability to invite all users of a company, whereas a user that is of a lower level account may only be able to invite other users of the same level, team, etc. In one case, a user’s account type may be based on the cost of the account, thereby providing additional features/functionalities for additional payment. In one case, meetings may be restricted to a type of user, a specific user, a set of users, etc.

In some cases, when a user is not able to attend a meeting, in lieu of attendance, a user may be presented with an interface to input preferences, desires, questions, etc. for what the user wants from the meeting, even though they cannot attend. For instance, if a user wants to have specific questions answered during the meeting, these questions can be pre-posed to the moderator through the meeting platform. These questions may be posted to a meeting’s board, and/or may be incorporated into a meeting’s AI bot.

Each meeting may have a board, which may be a type of living or live document, file space, white board, etc. where the substance of the meeting may be presented. The board may be hosted and managed by the meeting platform, as part of the meeting. The board may be created at the inception of the meeting invite. For example, when an organizer creates a meeting and a board may be created as part of that meeting creation. The board may be prepopulated based on a template (e.g., an ongoing project where known goals or objectives need to be shared/discussed, or an annual review of a vendor with specific items regarding the vendors report card that need to be discussed, etc.). The board may be blank unless otherwise modified to include pre-meeting data, such that the board may serve as the space where real-time and/or post-time analysis of the meeting can be made and placed on the board. The board may have specific sports of specific users; for a given user, they may input pre-meeting data (e.g., a question that they want answered during the meeting) which may be placed on the board, such as in the specific spot, or in a general question area of the board.

In some cases, for a given meeting a user may be able to subscribe to a meeting. By subscribing to a meeting, the meeting platform may then provide the user with information, notifications, etc., about the meeting without the user needing to be present in the meeting. In one case, subscribing to a meeting may additionally/alternatively cause the user to be represented within the meeting session such that one or more other participants of the meeting can see that the user present in, associated with, a participant of, and/or as a “subscriber” of the meeting, even though the user is not directly present. This representation may distinguish a subscribed user from a user who simply did not attend the meeting and who has not indicated any interest in the meeting content. In this manner, the act of subscribing may establish the user as part of the meeting's intended audience, which may affect how other participants communicate during the meeting and may cause the meeting platform to automatically deliver meeting materials to the subscribed user upon conclusion of the meeting. For example, if a user is subscribed to a meeting, then the user may get notifications associated with the meeting. The notifications may be before, during, or after the meeting, depending on configuration. In one case, the user may indicate (e.g., as part of subscribing) to receive specific data (e.g., files, recordings of the meetings, etc.) from a meeting. For example, an automatic push of the recording, meeting summarization, checklist/specific answers to questions, follow-up actions/communications, etc.

In one case, the user may provide feedback on information that they have received as a result of being subscribed to a meeting, such as positive/negative/question/etc. For example, on specific topics, a user may be able to comment, which would be part of the meeting’s board. In one case, feedback may be part of a pre-configured list, such as “this is great,” “I don’t like this,” or “needs more thought,” among other selectable and configurable options.

In some embodiments, the meeting platform may implement a subscribe-represent-deliver workflow that enables a user to remain meaningfully connected to a meeting that the user cannot attend. This workflow may comprise one or more aspects: subscribing to a meeting, being represented in the meeting, and/or receiving delivery of meeting materials.

In the subscribing aspect, the user may perform a lightweight (e.g., responding with some sort of modified response to a calendar/meeting invite) action indicating that the user wishes to remain connected to the meeting. The subscribing action may be distinct from joining the meeting and may not require the user to configure an AI bot, provide instructions, or perform any complex setup. For example, the user may select a subscribe option from a meeting invitation, a calendar entry, a dashboard, or another interface element of the meeting platform. The subscribing action may be comparable in simplicity to accepting a meeting invitation and may require no further input from the user beyond the initial indication of interest.

In the representing aspect, the meeting platform may cause the subscribed user to be represented within the meeting session in a manner that is visible to one or more other participants. The representation may take different forms along a spectrum of interactivity. In one embodiment, the representation may be minimal, comprising the user's name, avatar, and/or a status indicator (e.g., "subscribed," "represented," or a similar designation) displayed in a participant list, gallery view, or other participant-visible interface element, without any AI bot or automated participant being instantiated. In another embodiment, the representation may be a mid-level automated participant configured to respond to basic inquiries about the absent user, relay stored instructions or topics from the user, and/or take notes on behalf of the user. For example, if another participant asks whether the absent user is joining, the mid-level representation may respond conversationally, such as: "John couldn't make it today, but I'm here to take notes for him. He asked me to remind everyone about the budget topic. I will forward any message you give me for him." In another embodiment, the representation may be a fully interactive AI-driven participant that actively contributes to the meeting based on real-time meeting content, retrieved contextual data, and user-specific instructions, as described further herein. Each of these forms of representation, including the minimal form with no AI bot, may be part of the subscribe-represent-deliver workflow. In the delivering aspect, because the user was represented in the meeting, the meeting platform may automatically deliver one or more meeting materials to the user. Such materials may include, but are not limited to, meeting recordings, transcripts, summaries, action items, follow-up communications, attachments, and/or other meeting-derived content. The automatic delivery may be triggered by the user's represented state and may distinguish the represented user from a non-attendee who was not represented, where such a non-attendee may not receive automatic delivery of meeting materials.

In some cases, the user-accessible GUI of a dashboard may display all ongoing meetings or a set of ongoing meetings. The dashboard may also include upcoming meetings and past meetings. The dashboard may encompass all users or be specific to a user. In one case, a meeting may be selectable from a dashboard, and a user may subscribe or unsubscribe from the meeting. In one case, a user may select a meeting and details about the meeting may be presented. The meeting details may be modified by the user. The meetings details may include location (e.g., URL, phone number, etc.), estimated duration, duration limit, required participants, optional participants, a category of participants (e.g., other than optional or limited, such as management, team member, etc.), link to the board, time of day, time zone, participant contact information, backup date, links to filed (e.g., if they are not in the board), etc.

In some cases, there may be AI bots as user representatives in meetings. For example, if the user indicates that they cannot attend, then they user may have an option to “send” an AI bot to attend the meeting on their behalf. Additionally/alternatively, if the user needs to switch focus to another call/meeting (e.g., temporarily), the AI bot may be “switched on” for a given meeting.

In certain embodiments, the AI bot leverages large language model (LLM) architectures, such as transformer-based neural networks. These models are pre-trained on extensive corpora of text, which may include a wide variety of general and domain-specific data. By relying on the contextual understanding capabilities of an LLM, the AI bot can generate contextually relevant responses and engage with meeting participants in a manner that closely simulates human interaction.

Additionally, the system may incorporate machine-learning classification algorithms, such as random forests, logistic regression, or neural network classifiers, to identify user preferences, detect key topics during a meeting, or predict whether a given question requires the user’s attention. In more advanced configurations, reinforcement learning (RL) techniques can be employed to continually optimize the bot’s performance over time, rewarding the bot for successful interventions or meaningful contributions in a meeting.

Training of the LLM and related modules can be carried out through a combination of supervised and unsupervised approaches. In supervised learning, curated or synthetic training data—comprising meeting transcripts, user feedback logs, and other labeled interactions—are fed into the models to learn desired behaviors. In unsupervised or semi-supervised modes, large volumes of unlabeled text or recorded meetings are used to further refine the language understanding capabilities of the bot. Fine-tuning the models may involve user-specific datasets or domain-specific terminologies, ensuring the AI bot can address specialized topics pertinent to particular industries or departments.

Updates to these models can be performed on a scheduled or on-demand basis. For instance, the meeting platform may periodically download revised model weights from a central server, or it may integrate with external AI services that automatically push updated models when certain performance metrics are met or when new training data becomes available. Once updated, the AI bot seamlessly incorporates the latest model improvements, allowing the system to stay current with evolving language patterns, domain knowledge, and user-specific preferences.

Integration of these AI/ML models with the meeting platform occurs at both the backend and client-facing layers. On the backend, a dedicated AI management component processes live transcripts, meeting metadata, and user context in real time, returning context-aware responses for the AI bot to present in the meeting. On the front-end, a Graphical User Interface (GUI) enables users to configure AI bot settings, specify training preferences, and review analytics related to the bot’s performance. This modular design ensures that the AI functionality remains seamlessly embedded within the user’s standard meeting workflow without introducing significant overhead or complexity.

In additional embodiments, the present disclosure contemplates multiple deployment architectures — cloud-based, on-premises, or hybrid — to accommodate varying organizational requirements. In a cloud-based environment, the AI modules may run on scalable computing resources managed by a cloud service provider, allowing for efficient handling of surges in meeting volume or user load. By leveraging containerization or microservices frameworks, the platform may distribute tasks such as transcription, user context retrieval, and model inference across multiple nodes, dynamically allocating additional resources as meeting concurrency increases. This elasticity may allow users to experience minimal latency and may allow operations such as toggling the simulated participant or retrieving post-meeting reports to remain responsive even under peak loads.

In an on-premises deployment, the AI modules may be hosted within a company’s local data center or secure server environment. This setup is particularly advantageous for organizations with strict data governance, compliance, or security policies. The platform’s architecture permits the integration of edge devices—for instance, corporate telephony systems or private networking appliances—that can pre-process audio streams or route meeting data to the local AI modules. By reducing reliance on external internet connections, on-premises deployments can minimize latency and maintain stronger control over sensitive information.

A hybrid model combines the benefits of both cloud-based and on-premises arrangements. Core AI services, such as large language model inference or advanced analytics, can reside in the cloud for scalable, on-demand processing, while certain security-critical modules remain local to handle encryption, authentication, or specialized compliance needs. Edge computing devices can further distribute computational loads by performing initial data transformations or summarizations in real time, relaying only essential insights to the cloud for deeper analysis. This layered approach offers enterprises the flexibility to adapt resource allocation according to evolving workload patterns, user preferences, or regulatory standards. Ultimately, each architecture—cloud-based, on-premises, or hybrid—provides a robust infrastructure that supports seamless integration of AI-driven meeting functionalities with minimal disruption to existing communication workflows (e.g., timely, relative to the flow of the meeting).

An AI bot of a user may have a profile of the user that can be integrated or accessible by the meeting platform in order to create a custom and tailored persona for the context of a specific meeting. Based on the pre-meeting data (e.g., board, questions, etc.) input by any invitee of a meeting, prior feedback that the user has provided for a meeting (e.g., comments/feedback given prior to the beginning of the meeting), the AI bot may create a realistic (semi-realistic) presence of the user. For example, if a specific topic of interest or question pops up (e.g., through contextual transcription analysis by the AI bot), the AI bot may interact/provide input on behalf of the user that was previously provided by the user. Additionally/alternatively, if a specific topic of interest or question pops up (e.g., through contextual transcription analysis by the AI bot), the AI bot may notify the user so that the user only needs to pay attention for specific parts of the meeting that the user or the meeting’s organizer designates.

In one example, there may be a GUI for upcoming meetings and past meetings. On the left side of an interface, there may be an example of a schedule of meetings, and on the right side (e.g., where it may say “Past Meetings”), there may be an example of a GUI window that may be customized to show one or more interaction points (e.g., functions described herein).

For example, a user may click on an upcoming meeting on the left side and the right side would be updated with meeting information (e.g., as described herein). When a user makes updates to a meeting (e.g., modifying meeting details as described herein), that info may be saved on the meeting platform (e.g., or a repository, database, or the like a part of or operatively connected to the meeting platform) and then distributed (e.g., via meeting platform or another communications channel) to other users/endpoints and/or saved in the meeting record so that the organizers or other users may manage, modify, view, etc. the meeting details input.

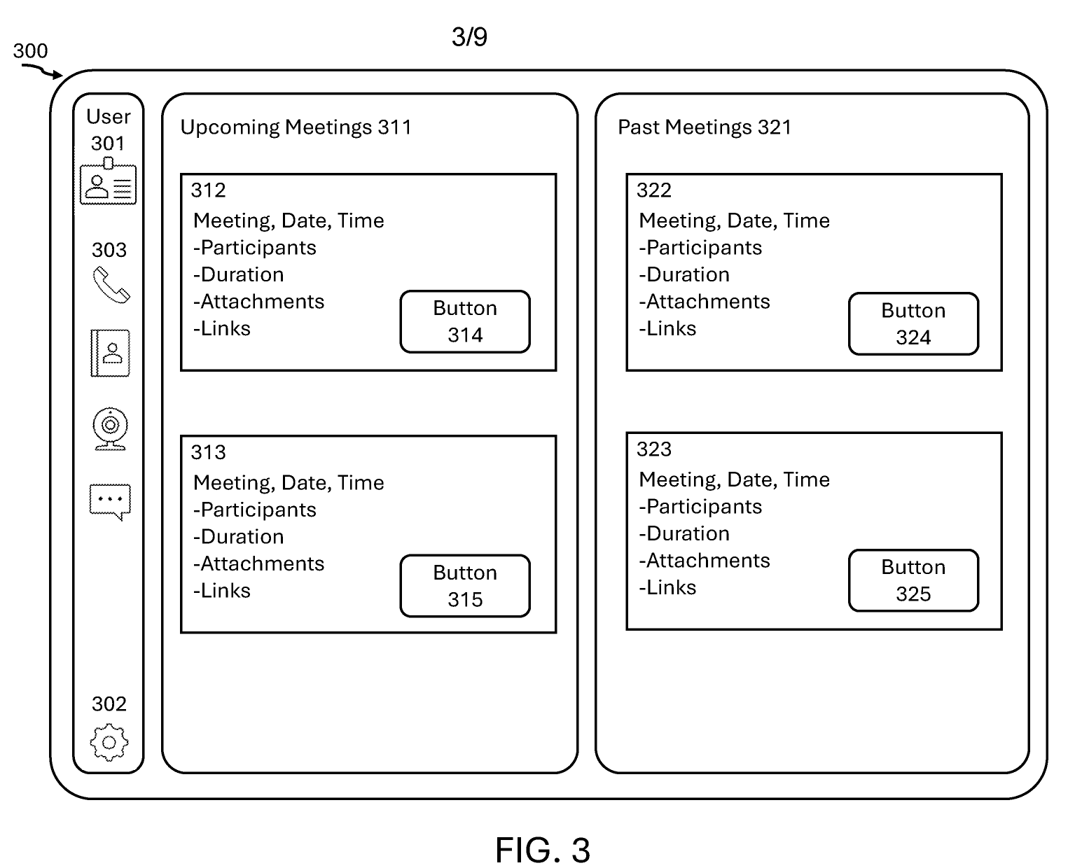

FIG. 3 illustrates an example of a graphical user interface (GUI) for management of meeting sessions, including upcoming meetings and past meetings. As shown, the interface 300 may be presented to a user 301 through a meeting platform and may include a first interface region 302 and a second interface region 303. The GUI may be presented via a browser-based client, desktop application, mobile application, and/or another user-facing interface of the meeting platform.

The first interface region 302 may present categorized meeting information. In the example shown, the first interface region 302 includes an upcoming meetings section 311 and a past meetings section 321. The upcoming meetings section 311 may list one or more upcoming meeting entries, such as meeting entries 312 and 313. The past meetings section 321 may list one or more past meeting entries, such as meeting entries 322 and 323. Each meeting entry may include one or more meeting attributes, including but not limited to a meeting identifier, date, time, participant information, duration information, attachment information, and/or one or more links associated with the meeting.

A meeting entry shown in the upcoming meetings section 311 may correspond to a scheduled meeting that has not yet occurred, while a meeting entry shown in the past meetings section 321 may correspond to a meeting that has already occurred. Selection of a given meeting entry may cause the second interface region 303 to update with meeting-specific information, controls, and/or content associated with the selected meeting. In one instance, the second interface region 303 may display additional meeting details, configuration options, uploaded materials, summaries, follow-up items, bot-related settings, AI-generated insights, and/or other meeting-specific data.

The interface 300 may include one or more selectable controls associated with the meeting entries. For example, upcoming meeting entry 312 may be associated with buttons 314 and 315, and past meeting entry 322 may be associated with buttons 324 and 325. The buttons may correspond to one or more meeting-management actions. Depending on implementation, such actions may include joining a meeting, opening meeting details, managing attendance, subscribing to updates, configuring a simulated participant or personal meeting bot, accessing attachments or links, reviewing post-meeting information, initiating follow-up actions, and/or other actions described herein.

In one embodiment, a user may select an upcoming meeting entry from the upcoming meetings section 311 to configure how the meeting platform is to manage that meeting for the user. For example, the user may configure attendance preferences, upload one or more bot instructions or supporting materials, specify discussion topics to be raised, subscribe to meeting outputs, and/or enable a simulated participant to act on behalf of the user during the meeting. The selected configuration may be stored by the meeting platform and associated with the corresponding meeting record.

In one embodiment, a user may select a past meeting entry from the past meetings section 321 to review post-meeting information. For example, the second interface region 303 may present a meeting summary, meeting recording information, transcript-derived content, bot analytics, follow-up items, approval or rejection options, unresolved questions, and/or links to downstream workflow actions. In this way, the GUI of FIG. 3 may provide a unified interface through which a user may manage pre-meeting and post-meeting interactions associated with multiple meetings.

In one example, a GUI for meeting settings may be provided. The interface may be labeled as the "Meeting Management Optimizer" but may be otherwise titled. The interface may present a scheduled meeting titled "Team Meeting 1," set for March 11 at 10:00 AM PST. The GUI layout may be divided into multiple interactive sections. On a left-hand pane, a vertical sidebar may display a list of upcoming meetings by date and time, including navigation options and the capability to start or join meetings. In one instance, the selected meeting, "Team Meeting 1," may be highlighted with a color or pattern indicator suggesting a predefined meeting, such as its importance or priority.

The central and right portions of the interface may comprise the meeting-specific controls and content customization. At the top, the platform may provide links to a meeting invite and associated linked documents. Directly beneath, users may indicate their attendance status by selecting from options such as "Attending," "Skip It," or "Subscribe To." A section labeled "Discussion Topics To Raise" may allow users to view, add, or modify agenda items, including action items tagged to specific users (e.g., "@Mike: Who is managing the team schedule?") and linked content documents (e.g., "Presentation content ideas").

Adjacent to the discussion section, a module labeled "Provide" may include interactive controls to link to the meeting recording, enable meeting summarization, and activate personalized summarization. A toggle switch below this module may allow users to enable or disable a "Personalized AI Bot," which may be intended to provide customized assistance or insights during the meeting.

A lower portion of the interface may include a "Comments" section, which highlights priority items for discussion, such as user assignments, and encourages collaboration by inviting user input. A "Follow-up Items/Actions" section may list post-meeting tasks, such as scheduling follow-up meetings and sending draft emails with presentation content. Based on these settings (e.g., pre-selected/pre-provided info from another user), information may be raised to an organizer, and/or other high-level user, or group of users. Information, indications, notifications, or the like may be sent out during a meeting based on events that happen during the meetings to resolve tasks/requests, cover specific questions and/or meeting topics, express feedback/sentiment (e.g., on specific topics), or the like.

In one case, skipping a meeting may not necessarily remove the user from the meeting's notifications and/or other related connections. For example, if the meeting is recurring, the user may have the option to skip one or more instances of the meeting. If the user selects to skip a meeting, the organizer may be notified. The user may be added back to any active role that the skipping would negate if the organizer chooses to do so or if the agenda changes. This function may also be carried out by the simulated participant, such as where the user has skipped the meeting but the agenda changes and the simulated participant determines to add the user back. Additionally, the user's simulated participant may be configured to skip meetings if the agenda is devoid of any mention of the user or the user's project.

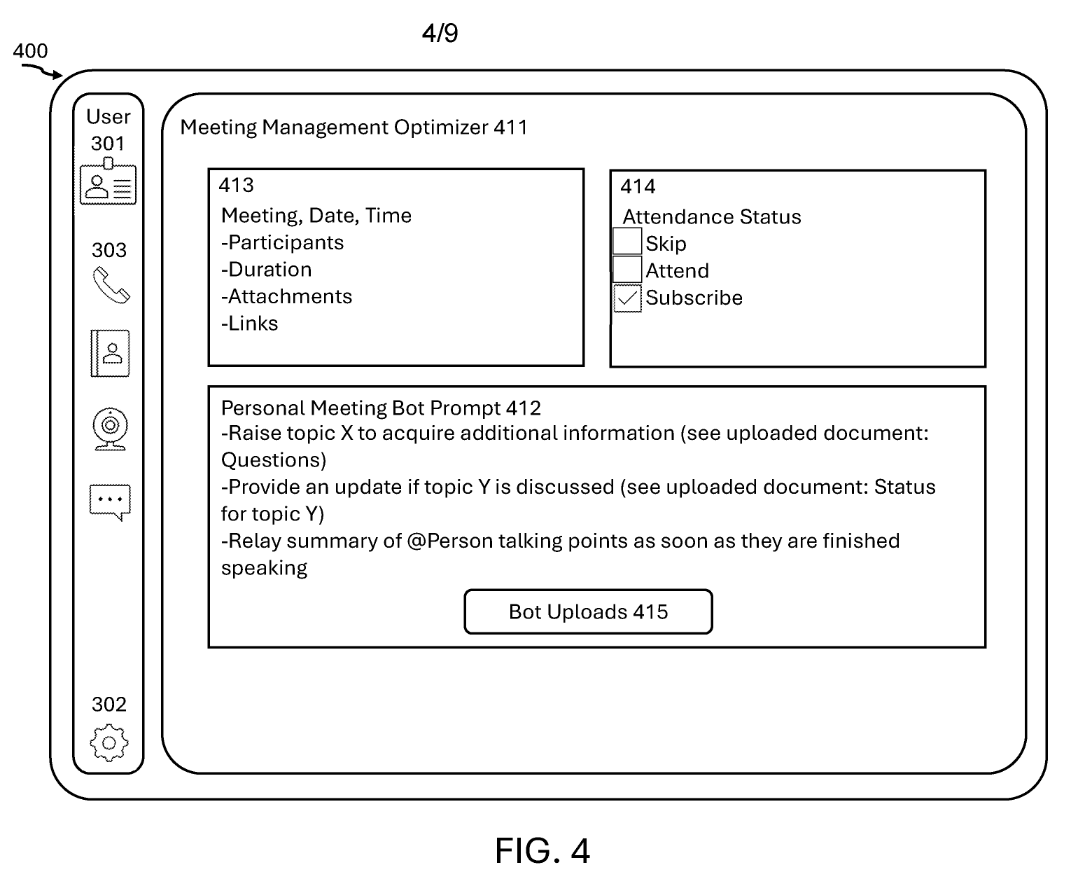

FIG. 4 illustrates an example of a graphical user interface (GUI) 400 for configuring management of a meeting and a simulated participant associated with the meeting. As shown, the GUI 400 may be presented to a user 301 via a meeting platform and may include an interface region 411. The GUI 400 may be accessed, for example, after selection of a meeting entry from the meeting management interface described with respect to FIG. 3.

In the example shown, the interface region 411 includes a meeting entry 413 associated with a selected meeting. The meeting entry 413 may include one or more meeting attributes, such as a meeting identifier, date, time, participant information, duration information, attachment information, link information, and/or other metadata associated with the selected meeting.

The interface region 411 may further include aspects of a meeting management optimizer. The meeting management optimizer, which may comprise one or more configurable settings, instructions, rules, preferences, and/or other inputs used by the meeting platform to determine how the selected meeting is to be managed on behalf of the user 301. For example, the meeting management optimizer may store or present one or more user-defined objectives, one or more topics to monitor during the meeting, one or more trigger conditions for generating an update, one or more instructions to request additional information, one or more response constraints, and/or one or more escalation conditions under which the user 301 is to be notified or invited to join the meeting.

As further shown, the interface region 411 may include a personal meeting bot (e.g., simulated participant) prompt 412. The personal meeting bot prompt 412 may include text-based instructions, prompt content, policy content, uploaded content, references to other data, and/or other configuration data usable by a simulated participant, agent, or bot configured to participate in the meeting on behalf of the user 301. In one example, the prompt 412 may specify that the simulated participant is to raise a particular topic, provide an update if a particular topic is discussed, summarize one or more participant statements, ask one or more predefined questions, and/or respond according to one or more user-defined preferences. Although a text prompt is shown, the personal meeting bot prompt 412 may additionally or alternatively include structured fields, selectable options, uploaded documents, external references, historical meeting data, calendar data, and/or other machine-readable configuration inputs.

The interface region 411 may further include attendance status controls 414. The attendance status controls 414 may allow the user 301 to specify a desired level of participation for the selected meeting. In the example shown, the attendance status controls 414 may include options such as skip, attend, and subscribe. In one embodiment, the selection of “skip” may indicate that the user 301 does not intend to directly attend the meeting, optionally while authorizing a simulated participant to attend or monitor the meeting on behalf of the user 301. The selection of “attend” may indicate that the user 301 intends to directly participate in the meeting. The selection of subscribe may indicate that the user 301 requests one or more meeting outputs, updates, summaries, alerts, or follow-up items without necessarily directly attending for the full duration of the meeting. Additional or alternative attendance states may be used in other implementations.

The interface region 411 may also include a bot uploads area 415. The bot uploads area 415 may permit the user 301 to upload one or more files, documents, notes, agendas, talking points, background materials, policy documents, issue summaries, and/or other meeting-related content for use by the simulated participant or by one or more AI-processing components of the meeting platform. In some embodiments, uploaded content may be ingested before the meeting, during the meeting, and/or after the meeting to improve context awareness, response generation, summarization, recommendation generation, and/or post-meeting workflow execution. In one case, the uploads may be stored in a data warehouse.

The interface region 411 may display supplemental information associated with the selected meeting and/or the selected configuration. For example, the interface region 411 may present a preview of bot behavior, configuration details, uploaded materials, recommended settings, generated summaries, analytics, related meetings, participant information, and/or other contextual content. In this way, the GUI 400 may enable the user 301 to configure both personal attendance preferences and machine-assisted participation behavior for a selected meeting through a unified interface.

Generally, there may be functionality/features to electronic meetings. For example, menu options may be updated to include the ability to toggle on/off a personalized AI bot that works off/analyzes meeting transcription relative to contextual meeting optimization of user (and/or group of users) described herein. There may be a toggle on/off contextual data insights that may be raised for the user (e.g., user-specific instance), for example, based on contextual meeting optimization of the user. In other cases, the meeting platform may generate general data insights for the entire meeting group and/or enable users the ability to share generated data insights with the meeting participants.

In one example, a GUI of a live meeting may be provided. The interface may depict an ongoing virtual meeting, with platform branding (e.g., "8x8") displayed in an upper region. At the center of the screen, a user icon labeled "JB" may represent an active participant. A rectangular overlay in a portion of the interface labeled "Data Insights – Team Meeting 1" may contain personalized meeting content generated by the system for the participant. The insight may specify that a user of a specific type DRI (Directly Responsible Individual) is Mike, who is tasked with managing the team schedule and distributing the schedule document. It may also indicate that the user's personalized AI bot will automatically raise these designated topics during the meeting.

In a region of the interface, a menu may be expanded, displaying active and configurable meeting features. These may include a confirmation that the "Personal AI Bot" is enabled, "Data Insights" are active, and options related to "Performance Settings," "Subtitles – Off," "Background," and "Stats." This menu may provide system configurability and real-time personalization capabilities designed to enhance user engagement and meeting productivity. A horizontal toolbar may be located at a lower portion of the screen, providing access to core meeting functions, such as muting, screen sharing, chat, and call termination. A prompt may offer the option to start recording the meeting, providing the meeting platform's ability to capture and archive session content.

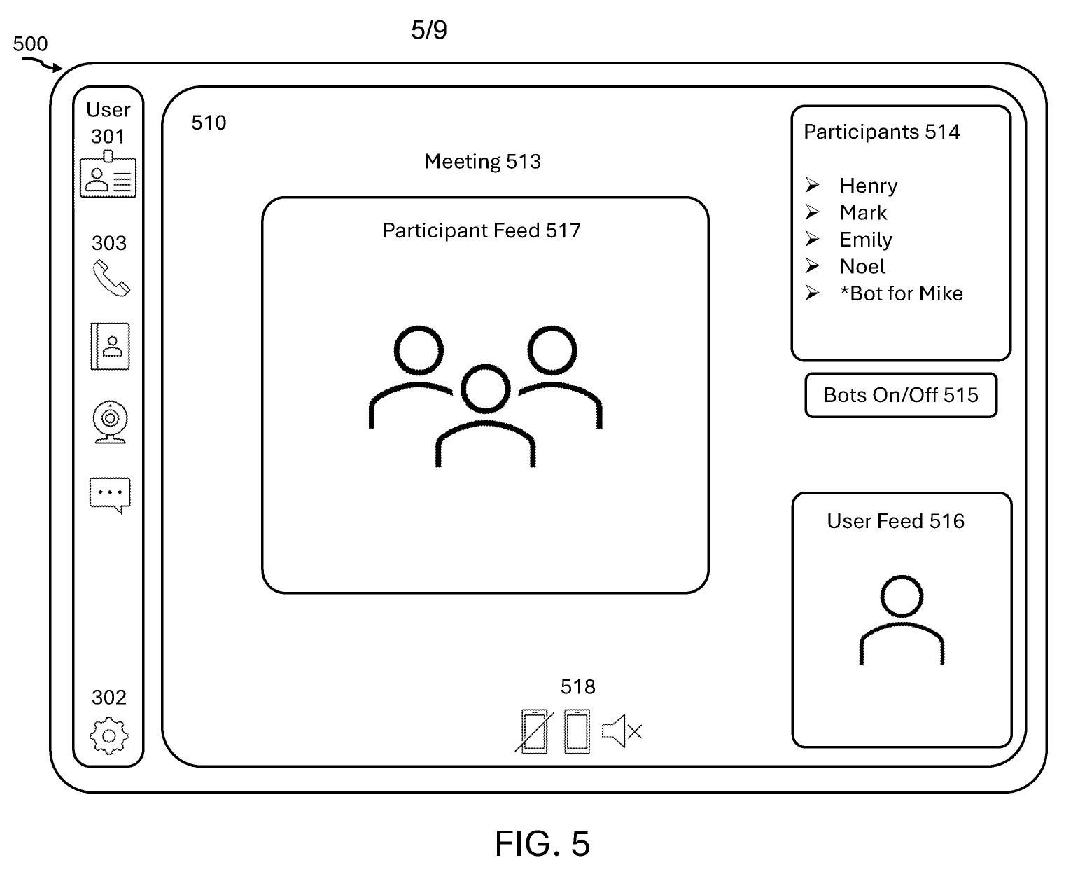

FIG. 5 illustrates an example of a graphical user interface (GUI) 500 of an active meeting session in which a user 301 may directly participate and/or monitor activity of a simulated participant associated with the user. As shown, the GUI 500 may include an interface region 510. The GUI 500 may be presented by a meeting platform during an ongoing meeting and may be accessible through a browser-based client, desktop application, mobile application, and/or another meeting client interface.

The interface region 510 may include a meeting area 513 corresponding to the active meeting session. The meeting area 513 may present one or more audio, video, text, transcription, and/or collaboration elements associated with the meeting. In some embodiments, the meeting area 513 may include one or more live presentation surfaces, shared content areas, chat areas, controls, visual indicators, and/or other meeting-session elements. The interface element 518 may correspond to one or more selectable controls, status indicators, overlays, notifications, or meeting-session tools presented in connection with the active meeting.

The GUI 500 may further include a participant's area 514. The participants in area 514 may identify one or more human participants and one or more simulated participants associated with the meeting. In the illustrated example, the participant's area 514 includes several individuals. In one case, it may include a bot for the User. This presentation reflects that a simulated participant may appear in the meeting as a participant-like entity on behalf of a user. In some embodiments, the participants area 514 may also indicate participant state information, including whether a participant is active, muted, absent, joined remotely, AI-assisted, and/or otherwise associated with the session.

The GUI 500 may further include a bots on/off control 515. The bots on/off control 515 may permit the user 301 and/or another authorized entity to activate, deactivate, pause, resume, and/or otherwise manage one or more simulated participants associated with the meeting. In one embodiment, activation of the bots on/off control 515 causes a simulated participant to join the meeting, monitor meeting content, and respond according to one or more preconfigured prompts, rules, permissions, or preferences, such as those described with respect to FIG. 4. In another embodiment, deactivation of the bots on/off control 515 may cause the simulated participant to stop generating responses, stop monitoring, leave the meeting, and/or transition into a passive state while the meeting continues.

The GUI 500 may also include a user feed 516 and a participant feed 517. The user feed 516 may present information directed to or associated with the user 301. For example, the user feed 516 may include user-specific notifications, detected topics of relevance, requests for approval, prompts to join the discussion, AI-generated recommendations, summaries, contextual insights, and/or alerts that a topic associated with the user is being discussed. The participant feed 517 may present information associated with one or more other participants and/or the meeting generally. For example, the participant feed 517 may include participant activity, chat content, speech events, meeting updates, AI-detected topics, generated summaries, task-related information, and/or other meeting-session outputs.

In one implementation, the meeting platform may analyze live meeting content during the active session and provide one or more outputs through the GUI 500 in real time or near real time. For example, the platform may monitor audio, video, text, and/or transcription content to determine whether a relevant topic, question, decision point, or action item has arisen. Based on that analysis, the platform may cause a simulated participant to speak, post text, surface a recommendation, request confirmation from the user 301, notify the user 301 to join the meeting, and/or store one or more meeting events for post-meeting processing.

In one embodiment, the simulated participant represented in the participants' area 514 may interact with the meeting on behalf of the user 301 while the user 301 is absent, partially attending, or concurrently attending another meeting. The simulated participant may be configured to ask one or more questions, provide one or more updates, respond to one or more statements, request clarification, monitor for one or more topics, and/or escalate one or more issues to the user 301. In this way, the GUI 500 may support dynamic coordination between human participation and machine-assisted participation within the same meeting session.

Generally, there may be a post meeting summarization. The summarization may enable ongoing contextual management of a meeting (e.g., where the meeting lives on after the actual meeting time since there may be follow up required, and/or the meeting is recurring, etc.). Any data point described herein may be incorporated into a post meeting summary. For example, post-meeting automation may include the ability to execute follow-up actions, open omnichannel communications (e.g., chats, message rooms, schedule follow-up meetings, and send communications (e.g., questions, surveys, based on templates, etc.). There may be a user checklist based on user pre-meeting configuration. Data may be populated to a specific user according to settings provided pre-meeting. The meeting platform may update (e.g., global) contextual info regarding participants of the meeting in real-time (near real-time) and/or at the post-meeting stage. For example, if a user did not previously select a personalized meeting summary, then the summary may still be generated at a later point in time based on at least an analysis of the meeting transcription, information gathered during the meeting (e.g., other than the transcription), and/or user meeting data (pre-meeting).

There may also be custom prompt fields for things like sending approvals. This may integrate with approval tracking integrations (e.g., Google, Smartsheet, Workboard, etc.) where approvals are tracked.

Insights may be user-specific and/or more general. In one instance, there may be time stamp references to user points of interest, for example, based on analysis of transcript and pre-meeting user data. Users may also share data insights, analytics, etc. through other data channels of software communications platforms, email, etc.

In one example, a post meeting interface may be provided. The interface may be labeled "Meeting Management Optimizer – Post Meeting." The interface may present a previously held meeting titled "Team Meeting 1," as indicated in both a meeting history panel and a main content area. On one side of the interface, a sidebar may display past meetings by title, date, and time, allowing users to navigate to completed sessions.

A main panel may be divided into multiple sections. At the top, users may be provided with access to post-meeting assets, including a Meeting Recording with an associated link, a Meeting Summarization link, and an option to Generate Personalized Meeting Summarization, which may be marked as unavailable (N/A) in certain instances.

Below this header, four columns may organize post-meeting actions and data. A User Checklist column may display key action items, such as "Team Schedule Manager," "Schedule Doc Sent Out," and "Presentation Content Ideas," with icons indicating completion status. A Sign-off section may enable users to approve, reject, or ask questions about the meeting outcomes, with action buttons and a submission interface directed to the DRI (Directly Responsible Individual), in this case tagged as "@Mike."

A Data Analytics column may display AI-generated metrics from the meeting, including a statement confirming that the AI Bot was active for 100% of the meeting duration and a representation of "Speaking Time (by participant)," which may convey participant engagement.

A Data Insights column may provide a contextual summary of meeting activities and tasks. It may confirm that Mike is responsible for sending the team schedule, include a timestamp of when the schedule document was sent, and highlight unresolved items such as "Presentation Content Ideas" to be addressed in the next meeting.

In one embodiment, the AI-augmented meeting platform begins by identifying overlapping meetings or resource constraints for a user. Prior to the meeting’s scheduled start time, the platform’s interface prompts the user to either attend in person or activate an “AI Representative Bot.” By selecting the AI Representative Bot, the user may configure meeting preferences, such as which topics the bot should address on their behalf and the scope of information the bot can share.

When the meeting commences, the AI Representative Bot joins as if it were the user. From the platform’s perspective, the bot has access to the user’s prior communications, stored data, and contextual notes specific to the meeting. For example, if the user had previously submitted questions or identified primary concerns, the AI Bot can automatically interject at relevant moments in the live transcript to ask these questions or provide background information the user would typically share.

During the meeting, the AI Bot actively monitors the conversation. If a critical topic arises—such as a question directed at the absent user—the Bot can respond based on pre-established parameters and historical data, effectively simulating the user’s input. In certain embodiments, the platform is equipped with real-time transcription capabilities and natural language processing (NLP) modules. These modules feed into the AI Bot’s decision-making process, enabling the Bot to confirm next steps or clarify points without requiring the user’s immediate attention.

Toggling the AI Bot on or off mid-meeting is facilitated by a user-facing control in the meeting platform’s interface. If the user becomes available, they can disable the AI Bot and resume personal participation. Conversely, if the user must momentarily step away, the user can switch the AI Bot to an active state, ensuring that key discussions are not missed. The platform logs these transitions, maintaining a clear record of when the user was personally engaged versus when the AI Bot was active.

Once the meeting concludes, a post-meeting report is generated. The post-meeting report indicates which contributions came from the simulated participant and compiles any relevant action items or decisions that arose while the user was absent. The user may then review a concise summary, complete with timestamps and direct links to audio or video segments that may require personal follow-up. In some configurations, the user may further train or refine the simulated participant's behavior by rating its performance or adjusting its decision-making parameters.

This operational example demonstrates how a user's presence in a meeting may be flexibly managed by the simulated participant. The adaptive activation of the simulated participant may allow users who are unable to attend multiple concurrent meetings to maintain effective communication and decision-making processes across the organization.

In one embodiment, a user prepares for a scheduled project update meeting by configuring a simulated participant within the meeting platform. During a pre-meeting setup phase, the user accesses a graphical user interface (GUI) to set parameters for the simulated participant, specifying particular topics of interest, priority items, and user-defined rules for engagement. The user may indicate, for example, that any mention of budget approvals or resource constraints should trigger an AI-generated prompt requesting additional details from the meeting participants. These preferences may be stored in the data warehouse 706 and retrieved when the meeting session begins.

Once the meeting starts, the platform initializes the user’s AI bot alongside human participants. The AI bot actively monitors real-time audio and text transcripts through natural language processing (NLP) modules. When relevant keywords or discussion points arise—such as a reference to “approved budget” or “resource allocation”—the AI bot flags these moments as critical insights. The meeting platform immediately surfaces contextually relevant insights in the user’s UI panel, prompting the user to view a brief summary of the discussion segment. This summary may include timestamps, speaker information, and any related follow-up questions the AI bot has automatically generated based on the user’s configured preferences.

The meeting platform presents these contextual insights in a dedicated sidebar or overlay window, displaying short text cards or notifications that highlight potential follow-up actions. For instance, when a team member mentions an upcoming milestone and requests additional resources, the AI bot infers that a separate meeting may be required to finalize resource allocation. The user sees a button labeled “Schedule Follow-up Meeting” within the insight notification. By clicking this button, the user triggers the meeting platform’s scheduling interface, pre-populating the new meeting invite with details from the current discussion, such as potential attendees and a suggested date range derived from the calendar availability data of key stakeholders.

In another scenario, the AI bot detects that a complex technical issue remains unresolved and recommends assigning a specific task to the engineer responsible for that component. A corresponding insight appears on the user’s screen with an “Add to Task List” feature. Upon selecting this option, the meeting platform automatically generates a task entry in the user’s productivity application (e.g., a to-do list, project management board, or ticketing system) with embedded links referencing the relevant portion of the meeting transcription. The system may also insert any associated attachments or documents directly into that task entry to provide comprehensive context for future reference.

Throughout the meeting, the user may fine-tune how often the simulated participant's insights appear. For example, if the simulated participant is surfacing too many trivial prompts, the user may adjust a relevance threshold control in the GUI. This control may modify the simulated participant's machine-learning classification parameters in real time, resulting in fewer but more focused insights. The meeting platform may log any adjustments to the simulated participant's behavior, such that subsequent sessions utilize the updated preference profile. At the conclusion of the meeting, a post-meeting report may collate all AI-generated insights, flagged timestamps, and user-triggered actions, such as scheduled follow-up meetings or assigned tasks. The post-meeting report may then be distributed to attendees or stored in a central repository, enabling efficient reference, future training of the simulated participant, or additional user review.

In one embodiment, a meeting organizer configures a simulated participant to host a recurring team meeting by populating a pre-configured agenda. Before the meeting begins, the organizer accesses a graphical user interface (GUI) within the meeting platform to define key discussion topics, specify time allocations, and identify data points to be collected from participants. This pre-meeting configuration may be stored in the data warehouse 706, where the simulated participant's agenda and talking points are associated with a unique meeting identifier.

When the scheduled time arrives, the simulated participant, operating as part of or in connection with the meeting architecture may automatically initiate the meeting session on behalf of the organizer. Upon each participant's arrival, the simulated participant may greet them via audio, video, or text channels, confirming their attendance and summarizing the main objectives of the meeting. Because the simulated participant has direct access to the pre-configured agenda stored in the data warehouse it may proceed through the topics sequentially, providing relevant prompts or questions for each item. For instance, if a technical update is required from a specific engineer, the simulated participant may reference the meeting's stored context and ask that individual to share their recent progress or blockers.

As participants respond, the simulated participant may listen to or transcribe their input using the content transcription and AI analysis, whenever a key data point is mentioned — for example, an estimated timeline for completing a particular project milestone — the simulated participant may automatically add this information to the meeting board. The board may be displayed in real time for all participants through the meeting client, ensuring that updates are captured and visible without requiring manual note-taking. In certain embodiments, the simulated participant may also format these additions into a structured list, table, or graphics enabling participants to quickly review newly captured information.

If a participant shares details that warrant follow-up actions, the simulated participant may proactively create relevant notifications. For instance, if a participant mentions that additional resources are needed to meet a deadline, the simulated participant may generate a task assignment or notify a designated manager of the resource request. This notification may be delivered via the task triggers of the external services or integrated with third-party tools, such as email or an enterprise collaboration tool, depending on the organizer's configuration preferences.

The simulated participant may track how much time is spent on each agenda item, comparing the actual time used with the allocations specified by the organizer. Should the discussion deviate from the plan, the simulated participant may remind participants that they have a limited window for each topic. Alternatively, if a particularly complex subject requires extended discussion, the simulated participant may adjust the meeting flow and update the meeting board to document the rescheduled agenda in real time. This adaptive approach may allow discussions to remain targeted while also accommodating unforeseen challenges.

By the conclusion of the meeting, the simulated participant may compile a post-meeting report of all agenda items covered, the data gathered, and any assigned follow-up actions. The post-meeting report may be posted to the meeting board, optionally tagging relevant participants for clarity or to request additional information. In some embodiments, the simulated participant may also deliver the post-meeting report and attachments, such as files, links, or external references, directly to each participant's device, such that the record of the meeting and associated tasks remains accessible.

In one embodiment, a meeting platform is provided with an integrated AI bot configured to both organize and participate in virtual or in-person meetings. The AI bot is granted access to an enterprise calendaring system, a user’s project management tools, and/or a data repository containing relevant documents. Before a scheduled meeting begins, one or more users provide contextual information to the AI bot, such as prior meeting notes, objectives for the current meeting, and a list of planned attendees. The AI bot processes this data using a natural language processing (NLP) module and infers potential agenda items and discussion points based on past outcomes, pending tasks, and priority levels gleaned from user emails or project status dashboards.

During the meeting, the AI bot actively monitors the conversation, either via direct integration with a conferencing platform (e.g., a plug-in to a voice and video meeting service) or by receiving audio/video feeds in real-time. As the discussion unfolds, the AI bot continuously interprets spoken language or chat messages through NLP algorithms. These algorithms identify key topics, action items, and questions posed by participants. If the AI bot detects a critical piece of missing information—for instance, a reference to an outdated specification or the mention of a document not yet accessed by participants—it automatically fetches the relevant documentation from the data repository. The AI bot then either shares a link with the meeting’s chat window or displays the document on a shared digital whiteboard interface, providing immediate access to pertinent information.

In certain implementations, the AI bot maintains a dynamic meeting agenda that it adapts in real-time. If a participant raises a new issue that was not originally listed in the pre-meeting agenda, the AI bot analyzes the request, determines its urgency and relevance based on context from prior meetings, and appends the topic to the active agenda. Participants can then view this updated agenda within their user interfaces of the meeting platform (e.g., board, a shared notes document, or a virtual space). The AI bot may also prioritize or reorder topics if it infers that an item is time-sensitive—for example, if the team is approaching a product launch date, the AI bot may move critical launch-related discussion points higher on the agenda.

As discussion proceeds, the AI bot continuously tracks which action items are resolved or remain open. Upon detecting that a follow-up session may be needed—such as when a topic cannot be completed due to the absence of a key stakeholder—the AI bot automatically identifies potential times for a subsequent meeting by querying the scheduling system for participant availability. The AI bot then proposes one or more time slots through an interface (e.g., a pop-up window) to the group, taking into account user preferences (e.g., pre-configured) (e.g., blocking out certain afternoons for engineering sprints). Once the participants agree on a proposed time, the AI bot finalizes the invitation and sends out meeting links, automatically attaching relevant documents or previous notes to ensure continuity from the current session to the next.

Additionally, the AI bot may dynamically add participants to the current or subsequent meeting if it detects that these participants are essential for the discussion. For instance, if the conversation shifts to budget allocations, the AI bot may detect that a finance manager’s expertise is required. In response, the system may prompt the meeting organizer to invite the finance manager, or automatically generate an invitation if the meeting organizer has given the AI bot the authority to do so. This authority may be predefined in user preferences or organizational policies. The AI bot’s identification of such participants may be based on stored user roles, past attendance logs for similar topics, or keyword matching that links certain employees to specific areas of expertise.

In one example scenario, if the participants debate two competing proposals, the AI bot may reference historical metrics—for instance, cost data or customer feedback—in real-time. By retrieving these metrics from the company database, the system helps accelerate decision-making, as participants can view side-by-side comparisons of outcomes for each proposal. If further discussion is required with a subject-matter expert who is not currently in attendance, the AI bot may automatically suggest scheduling a mini-session with that expert. Upon participants’ approval, the AI bot identifies suitable time slots for the expert and reconfigures the calendar invites. Once the additional session is confirmed, the system instantly updates project management workflows and populates any newly identified tasks (e.g., drafting design mock-ups or gathering test data) into the team’s task tracking software.

Following the meeting's conclusion, the post-meeting AI processing 707 may generate a post-meeting report of the session, highlighting key decisions, open issues, and assigned tasks. The post-meeting report may then be transmitted to each participant via the report generation 710, along with embedded links to pertinent documents and automatically created calendar events for all scheduled follow-ups generated by the task triggers 709. Additionally, the post-meeting report may be posted to the meeting board.

In one embodiment, the meeting platform may provide basic organizational actions through the interface may be triggered and/or interacted with either by a human user or by an AI bot operating on the user’s behalf. To initiate a meeting, a user may select a “Create Meeting” option from a graphical user interface (GUI), specifying an initial date, time, and list of participants. Alternatively, the AI bot, upon detecting the need for a meeting (e.g., due to an unresolved agenda item or a newly discovered conflict), can autonomously propose and schedule the meeting (e.g., an AI module interacting with a scheduling module of the meeting platform). This meeting creation process may involve cross-checking participant calendars using integration modules as described above, ensuring minimal scheduling conflicts.

Once a meeting has been created, either the user or the AI bot may handle participant invitations. For instance, the AI bot can automatically invite collaborators identified in project documentation or prior discussions, thereby reducing the burden on the organizer. In certain implementations, the AI bot’s NLP module analyzes keywords or topics in user communications (such as “budget review,” “legal sign-off,” or “technical update”) to infer which team members hold relevant expertise. When those individuals are identified, the system’s recommendation engine automatically populates their contact details and sends them meeting invitations. Similarly, un-inviting a user may be accomplished by a command or by the AI bot’s inference that a participant is no longer required (for example, if the discussion moves away from their area of responsibility). In such cases, the AI bot may generate a revised invitation list and issue withdrawal notifications to the removed participants.

To accommodate dynamic changes, the meeting platform enables either the AI bot or the user to modify meeting details at any time. For example, participants may discover they require more time to prepare materials, or another high-priority issue may arise that justifies amending the meeting agenda. Users may manually edit meeting details via the GUI, while the AI bot may independently update scheduling parameters if it detects new constraints—such as a conflicting engagement on a key decision-maker’s calendar. The AI bot may also update textual descriptions, attach or remove relevant documents, or alter the meeting’s modality (e.g., switching from an one communications channel to a another (e.g., Zoom to 8x8, etc.) based on instructions or context gleaned from chat logs, project management tools, or user preferences/interactions known to the AI bot. Additionally/alternatively, the AI bot may be given access to a user’s notes or work data such that it can constantly monitor a project status and determine when a new meeting needs to be scheduled based on the project hitting a specific milestone.

When the meeting time or date needs to be changed, the AI bot may automatically scan all invitees’ calendars to locate a mutually available timeslot, potentially sending a poll or recommendation list to participants for confirmation. Additionally/alternatively, the AI bot may assess priority information if none of the meeting participants are available in order to schedule a meeting even though a conflict for at least one invitee exists. Additionally/alternatively, the AI bot may knowingly schedule overlapping meetings given the functionality described herein that may enable a user to have and/or participate (directly or indirectly) in more than one meeting at a time. In addition, the meeting platform provides a “meeting board,” which can be a shared digital workspace or chat channel. Both users and the AI bot can post updates, agenda items, or clarifications to this board in real-time. By maintaining a persistent record of decisions, suggestions, and follow-up tasks, the meeting board ensures that all participants remain informed.

The meeting platform may facilitate recurring and/or dynamically recurring meetings. A recurring meeting may be set manually by the user—e.g., “every Monday at 2 PM”—or suggested by the AI bot if it notices a pattern (such as recurring weekly check-ins for project status). In more advanced scenarios, the AI bot may establish a dynamically recurring meeting, wherein the meeting automatically reschedules itself upon a trigger, such as the completion of a milestone, the completion of another meeting or set of meetings, the creation of a new user or addition of a new user to a team, etc. For instance, if a project plan indicates that a milestone is expected to be completed in three weeks, the AI bot may tentatively schedule a follow-up meeting for that time frame. If the milestone is completed sooner, the AI bot may detect this from integrated project management data and trigger an immediate or earlier meeting. Conversely, if the milestone is delayed, the AI bot may automatically adjust the meeting schedule and alert participants to the new date or time. By leveraging these dynamic scheduling capabilities, teams can ensure that critical discussions take place at the most opportune moments without requiring constant manual intervention.

In accordance with various examples described herein, the present disclosure offers significant technical advantages by enabling a software communications platform to pre-determine and preset application or service settings in the interest of operational efficiency. Rather than requiring ad hoc configurations for each meeting or communication channel, the system may store, retrieve, and apply user preferences automatically. This feature reduces the overall computational overhead and time spent repeatedly adjusting configurations (e.g., audio/video settings, AI bot participation parameters, or integration with third-party tools). Because the platform is able to immediately load these pre-configured options, fewer queries to external databases or modules are required, thereby alleviating the processing burden on both local devices and server-side infrastructure.

The platform may provide an integrated approach to omni-channel communications management and data distribution. By centrally orchestrating functionality such as meeting recordings, meeting summarizations, and project management approvals, the system may consolidate discrete processes into a streamlined workflow. For example, if a recording is generated by the platform, it may be automatically tagged with relevant metadata for retrieval or sharing with authorized stakeholders. Once a meeting summarization is produced, it may be distributed through configured channels — such as email, messaging integrations, or custom dashboards — without requiring manual uploads or additional third-party bridging. This may improve operational efficiency and data consistency across different communication channels.

By proactively reducing the need for future electronic meetings to disseminate the same information, the techniques described herein may help conserve processing resources on both the client side, such as user devices, and the server side, such as cloud-based infrastructure. When the system automatically captures and shares pertinent information, including summaries, action items, or key decisions, users may reference these materials asynchronously, thereby avoiding redundant or unnecessary live sessions. This may decrease total bandwidth consumption and free up CPU and memory resources that would otherwise be expended handling multiple concurrent sessions. In doing so, the techniques described herein may optimize not only the human time spent in meetings but also the underlying computational resources that support them.

Furthermore, the communications software platform, such as 8x8 Work or a similar unified communications system, may be adapted to include a specialized graphical user interface (GUI) for carrying out preloaded settings and efficient workflows. Unlike legacy off-the-shelf solutions, this adapted GUI may be configured to funnel user inputs, AI-driven insights, and channel-specific settings into an integrated application layer. As a result, new or modified features, such as toggling a simulated participant on or off, distributing meeting artifacts to project management boards, or approving time-sensitive action items, may occur without requiring separate, resource-intensive processes. This may offer a practical application of the techniques described herein, in which customization and adaptability may serve as enablers of a holistic, low-latency meeting experience that aligns with modern business needs.

From a hardware perspective, integrating AI-driven inference directly into the unified communications platform may allow data collection and preliminary analysis to be conducted in-stream and in near real-time, rather than routing raw data between multiple remote services. This local or near-edge processing architecture may reduce the number of round-trip operations and may alleviate load on central servers. In practical terms, this may reduce CPU cycles spent on data formatting or re-transmission and may reduce bandwidth dedicated to uploading and downloading data, thereby freeing system resources for higher-priority tasks and real-time operations.

In some embodiments, the system may utilize specialized AI accelerators or graphics processing units (GPUs) in a targeted manner. Because the communications platform may aggregate and preprocess relevant data in a structured format, AI models may run inference tasks without incurring overhead from irrelevant or redundant data streams. By reducing the data volume before passing it to specialized hardware, the platform may reduce the memory footprint and processing load, allowing GPUs or dedicated AI chips to achieve higher throughput with lower latency and enabling more simultaneous user interactions without requiring proportionally higher compute resources.

Additionally, the AI component of the platform may incorporate caching mechanisms that store commonly needed context locally—either in fast-access memory on the client or in server-side caches that are closely coupled with the AI models. This strategy minimizes repeated lookups over the network, reduces bandwidth usage, and/or allows the system to generate responses with less reliance on external database queries. With data cached closer to the AI inference engine, the overall system can achieve a higher rate of queries per second (QPS) on existing hardware, maximizing resource utilization and efficiency.

Additionally/alternatively, by embedding the solution natively within different host applications and services, the system can offload processing to whichever hardware is most suited for a specific task. For instance, low-latency data transformations might be performed on edge servers physically closer to the end user, while more computationally intensive AI training steps may be scheduled on centralized clusters equipped with large GPU arrays. This kind of adaptive load distribution allows for more effective resource allocation, keeps latency in check, and ensures that hardware resources are used optimally across the entire system.

Non-limiting examples of the present disclosure may be implementable as processing improvements for stand-alone applications or services, which can also be integrated into software computing platforms (“software platforms”). As software data platforms have layers of complexity, technical problems identified herein can be amplified in such implementations which further illustrates the technical advantages presented in the present disclosure. As such, some examples of the present disclosure may be provided in connection with a software platform such as a software communications platform. An exemplary software communications platform provides digital tools and services that enable real-time (or near real-time) information sharing and collaboration amongst users. An example of a software communications platform may be a cloud-based communications platform (cloud-based platform implementation) such as 8x8 Work® made available by 8x8, Inc. (e.g., additional supporting documentation available at http://www.8x8.com), among other examples.

The present disclosure is implementable to adapt and improve not only back-end data processing of a software platform but also front-end representations to users provided through a software platform providing further tangible evidence of the technical benefits of the present disclosure. For instance, this can be accomplished through data processing management for computer hardware and software utilized for provision of an exemplary software communications platform via data orchestration (e.g., data flow management for execution of processing components and related applications/services), data integration (e.g., bot connection to applications/services of a software communications platform); and data creation/retrieval (e.g., generation of contextual data insights and suggestions for developers and/or end users). Furthermore, benefits of the present disclosure may yield an improved graphical user interface (GUI) that may be adapted to enable usage of data integrations (e.g., chatbots) and surface contextually relevant data insights, suggestions, etc. for developers and/or end users presentable via applications, services, software platforms, and associated computing devices (e.g., user computing devices).

Non-limiting examples describe systems and methods for data integrations with/within software platforms. For instance, one or more bots may be integrated into a software communications platform to perform specific communications-based tasks associated with features and functionalities provided through a software communications platform. A bot may be a software program configured to interact with systems or users for the performance of specific tasks. In the context of a software communications platform, a bot may be utilized to be directed to communications tasks including management of conversations and associated data/ metadata for communication management purposes (e.g., a chatbot). For ease of explanation, a chatbot may be used to describe examples of the present disclosure including within software communications platforms. However, it should be recognized that the present disclosure is able to be configured to work with any type of data integration in any application/service or software platform.

An exemplary software communications platform may include any technology described herein as “cloud-based platform implementation” individually or collectively. In one example, an exemplary software communications platform may comprise but is not limited to a combination of UCaaS, CPaaS, CPaaS features and functionalities, web services, and connected websites, administrative portals/consoles, connected to system infrastructure including phone systems hosted remotely by servers and accessible via the internet. An exemplary software communications platform can uniquely generate and manage contextual data from components and users thereof, which can then be leveraged cross-platform and further with third-party integrations services, platforms, (e.g., including integrations via API) to provide a rich and contextual omni-channel user experience (e.g., across a plurality of communication channels including voice, electronic meetings, chat, email, messaging, digital messaging, social media) that is accessible through an adapted GUI. An adapted GUI of a software communications platform may be configured and presented as a single unified workspace but can also be represented in via a plurality of GUI workspaces, collapsible and expandable, including break-out GUI functionality to help manage control over communications across different communication channels (omni-channel). Non-limiting examples of features and functionalities of an exemplary software communications platform comprise: omni-channel communication functionality; bot integrations including conversational chatbots (including AI/ML integrations); workforce management (e.g., supervisory management of users such as agents, enterprise resource planning); data analytics (including user-specific, device-specific, software service-specific such as UCaaS or CCaaS, and/or aggregated); ML/AI integrations for data processing, analysis and augmentation including query/response capabilities, translation, transcription, summarization, sentiment and/or biometric analysis, data insight generation, and generation of recommendations or automation of actions within platform; reporting/report generation; customer relationship management (CRM) tools; device management (e.g., phones including both physical phone devices and softphones, PBX, phone numbers, porting, etc.); issue management including support and help desk ticketing management; transaction processing (including payment transactions); billing management; administrative management control including administrative console apps/services to enablement management of users via user profiles, device profiles; phone systems; works groups, ring groups, call queues, group paging, overhead paging, barge-monitor-whisper); IVR; call routing and distribution; call recording functionality; data storage (e.g., including control over hot and cold storage); phone dialers; conversation management including messaging via chat (individual and group), SMS/MMS, including messaging campaigns, website management, and management of service availability, among other examples.

Non-limiting examples of technical advantages provided based on the one or more techniques described herein, may include, but are not limited to: provision of an improved data orchestration layer for management of data integrations with applications or services and related computer hardware; an adapted software communications platform with improved visibility into processing components further enabling improved issue spotting, remediation, and extend scalability and adaptability of software platforms via data process flow management of data integrations with/within the software platforms and associated system architecture (e.g., bot integrations with a cloud-based communication platform); improved processing efficiency (e.g., reduction in processing cycles, saving resources/bandwidth) for computing devices performing data orchestration, including creating data flows for digital communication across software platform(s), as well as data integration, including integration of bots in applications, services, and software platforms; reduction in latency of computing devices supporting software platforms which can include reduction in latency for back-end computing processing and resulting front-end output during execution of a software platform (e.g., software communications platform); creation, training, and adaptation of artificial intelligence (AI) modeling (e.g., machine learning (ML)) integrated within applications/services for processing improvement across a variety of practical of applications including data orchestration (e.g., data flow management for execution of processing components and related applications/services), data integration (e.g., bot connection to applications/services of a software communications platform); and data creation/retrieval (e.g., generation of contextual data insights and suggestions for developers and/or end users); an improved graphical user interface (GUI) adapted to surface contextually relevant data insights, suggestions, etc. for developers and/or end users including in applications, services, software platforms; and improved usability (user experience) of host applications/services including customization of data and data augmentation for usage of applications/services, and software platforms (e.g., software communications platforms), among other technical advantages.

In one case, an AI component of the meeting platform may pull data from all parts of a communications platform. The AI component may train a model in real time in order to better answer queries, make determinations, and the like, such as those functions described herein with respect to the meeting platform.

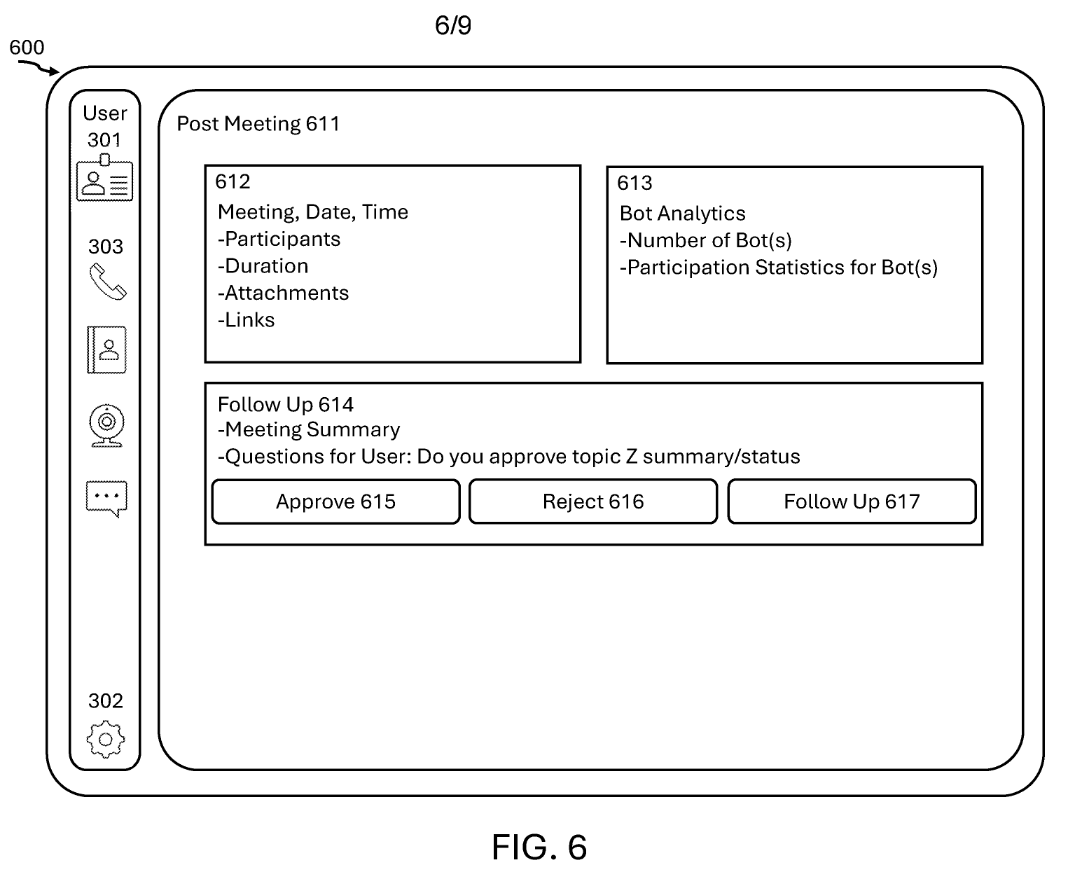

FIG. 6 illustrates an example of a graphical user interface (GUI) 600 for post-meeting management and review of meeting outputs associated with a selected meeting. As shown, the GUI 600 may be presented to a user 301 via a meeting platform and may include an interface region 611. The GUI 600 may be accessed after the conclusion of a meeting and may present one or more post-meeting artifacts, analytics, and follow-up controls associated with the meeting.

In the example shown, the interface region 611 includes a meeting entry 612 corresponding to a selected meeting. The meeting entry 612 may include one or more meeting attributes, such as a meeting identifier, date, time, participant information, duration information, attachment information, link information, and/or other metadata associated with the meeting. Selection of the meeting entry 612 may cause the interface region 611 to present post-meeting information associated with that meeting.

The GUI 600 interface region 611 may be for the display of post meeting interface elements. The post meeting section 611 may present one or more post-meeting outputs generated by the meeting platform. For example, the post meeting section 611 may include a meeting summary, one or more transcript-derived outputs, one or more questions for the user, one or more approval prompts, one or more status indicators, and/or links to a meeting recording, transcript, summary, or other meeting artifact. In the illustrated example, the post meeting section 611 includes a meeting summary and a prompt asking the user whether the user approves a summary or status associated with topic Z. More generally, the post meeting section 611 may present AI-generated or rule-generated outputs for review by the user after the meeting has ended.

The GUI 600 may further include a bot analytics section 613. The bot analytics section 613 may present information associated with one or more simulated participants, personal meeting bots, and/or other automated meeting entities used during the meeting. For example, the bot analytics section 613 may include a number of bots that participated in the meeting, participation statistics for one or more bots, duration of bot activity, number of interventions made by a bot, detected topics addressed by a bot, response timing information, user-specific relevance determinations, escalation events, and/or other performance-related metrics. In some embodiments, the bot analytics section 613 may be used by the user 301, an administrator, and/or another authorized entity to assess how a simulated participant performed during the meeting.

The GUI 600 may also include a follow up section 614. The follow up section 614 may present one or more post-meeting actions, unresolved issues, next-step items, assignments, reminders, communications, and/or workflow triggers associated with the selected meeting. In some embodiments, the follow up section 614 may include user-specific follow-up items derived from pre-meeting configuration data, live meeting events, transcript analysis, meeting decisions, participant statements, and/or external system data. The follow up section 614 may also interface with one or more downstream systems, such as messaging systems, calendaring systems, approval systems, task-management systems, customer relationship management systems, project-management systems, and/or other workflow platforms.

As further shown, the GUI 600 may include one or more selectable controls, such as approve control 615, reject control 616, and follow up control 617. The approve control 615 may permit the user 301 to approve one or more summaries, recommendations, proposed actions, decisions, and/or other post-meeting outputs. The reject control 616 may permit the user 301 to reject, correct, or request revision of one or more post-meeting outputs. The follow up control 617 may permit the user 301 to initiate, assign, transmit, store, escalate, or otherwise manage one or more follow-up actions based on the meeting results. Although three controls are shown, additional or alternative controls may be presented depending on implementation.

In one embodiment, the meeting platform may generate the content displayed in the GUI 600 based on analysis of meeting content captured before, during, and/or after the meeting. For example, the meeting platform may analyze meeting transcription data, audio data, video data, shared content, uploaded materials, user-provided instructions, simulated participant activity, and/or historical meeting data to generate summaries, identify questions for the user, determine bot analytics, and recommend follow-up actions. In one instance, if the user did not request a personalized summary before the meeting, the platform may still generate a post-meeting summary after the meeting based on one or more of the meeting transcript, meeting artifacts, and user-related meeting context.

In one embodiment, the GUI 600 may enable a user to continue managing a meeting after the live session has ended. For example, the user may review a meeting summary, assess contributions made by a simulated participant, approve or reject one or more AI-generated outputs, and trigger one or more follow-up communications or tasks. In this way, the GUI 600 may support continued meeting-related activity beyond the live session itself and may reduce the need for additional manual coordination.

There may be an AI platform that is a part of the meeting platform and/or the communications platform. The AI platform may be a component in a system, such as a communications system. In one implementation, an AI Platform comprises a set of building blocks (e.g., for 8x8), in which various services and integrations operate together within a cloud-based communications platform (e.g., 8x8). The 8x8 Services section is divided into distinct layers and components—some of which may be "Shared," "UC only," "CC only," or "Platform" services—to signify their roles in supporting different communication and contact center functions. The architecture includes "Digital Channels" (such as voice, messaging, and social) feeding into 8x8's Voice/Digital Core & Gateway, which in turn connects to global telco networks, SIP adapters, and third-party BYOC (Bring Your Own Carrier) PSTN options. Within the 8x8 Services block, the "8x8 Customer Interaction Data Platform" and the "8x8 Integration Framework" aggregate data and orchestrate third-party connectors or workflows.

Outside a main 8x8 Services block, there may be specialized AI components—like "8x8 ASR" (Automatic Speech Recognition), "8x8 LLM" (Large Language Model), as well as external ASR, LLM, and CRM or knowledge base integrations—signifying that AI can be both native to the 8x8 platform or pulled in from external vendors. These AI capabilities feed into the "8x8 TPES" ring, which is associated with various enterprise and customer-facing functions such as AI self-service, customer relationship management, workforce engagement, and IT operations. A designation differentiates which modules or services belong exclusively to UC (Unified Communications), CC (Contact Center), or shared "Platform" layers, while a "Default" or "BYOC" marker indicates the deployment flexibility. Altogether, the architecture conveys how 8x8's unified communications and contact center services—along with multiple AI and data layers—form a comprehensive, integrated platform capable of drawing on both native and external AI models to deliver omnichannel solutions and insights.

In the AI platform, there may be one or more additional/alternative data endpoints. The AI component of the platform may gather and analyze various data endpoints across multiple dimensions. From Voice and Digital Core & Gateway Data, the system collects call metadata and recordings, including inbound and outbound call details, real-time and recorded audio streams, Call Detail Records (CDRs), and call routing logs. Additionally, digital channel logs, such as conversation data from SMS, messaging apps, and social channels routed through the 8x8 gateway—including timestamps, sender and recipient IDs, and message content—provide valuable insights.

Integration with Global Telco and Public Switched Telephone Network (PSTN) allows the AI component of the platform to access network connection details, such as carrier-specific routing records, call-connection quality metrics, and logs from Bring Your Own Carrier (BYOC) interfaces. It also evaluates real-time telephony metrics like jitter, latency, and throughput statistics, which can impact call quality or influence routing decisions.

The 8x8 Customer Interaction Data Platform may contribute data from cross-channel interaction history by unifying logs from calls, chats, emails, and/or social interactions tied to specific customer or agent identifiers. This is complemented by customer profiles and interaction context, providing consolidated data points on customer preferences, past issues, and account statuses.

Contact Center (CC) and Unified Communications (UC) service layers may offer additional data points. CC data includes agent performance metrics, queue information, skill-based routing configurations, post-call wrap-up codes, and records from ticketing or case management systems. UC data comprises meeting schedules and logs, presence indicators, transcripts from team messaging, and shared workspace documents.

The 8x8 Integration Framework incorporates third-party system records from external Customer Relationship Management (CRM) platforms, knowledge bases, and/or billing systems, including detailed account information, ticket history, and product usage logs. It also captures workflow orchestration events triggered by third-party services, such as automatically opening support tickets or initiating marketing automation processes.

AI services, both native and external, may also provide data endpoints. The 8x8 Automatic Speech Recognition (ASR) may capture real-time or post-call transcripts, confidence scores, speaker identification data, and/or partial transcripts for live assistance. The 8x8 Large Language Model (LLM) may offer text analytics outputs, including but not limited to, summarized call notes, sentiment scores, and/or intent detection results. External AI integrations may enhance these capabilities by providing similar analytics, potentially including specialized and/or brand-specific insights.

Additionally, CRM, knowledge base, and/or external connectors may supply additional endpoints such as customer account records like purchase histories, support ticket details, and/or product usage data. They also offer insights into knowledge base interactions, identifying frequently accessed articles, their resolution rates, and topics leading to escalations. Targeted Platform Engagement Services (TPES) may collect AI self-service logs to track user interactions with bots or self-service portals, assessing the frequency, types of requests resolved, and/or customer engagement metrics such as interaction outcomes, usage patterns, and AI workflow success rates.

In centralizing and analyzing these comprehensive and diverse data points, the AI component of the platform may deliver richer, real-time insights. This enables the identification of patterns in customer sentiment, automation of routing and ticket assignments, context-aware support for agents, and predictive analysis of future customer needs and potential challenges.

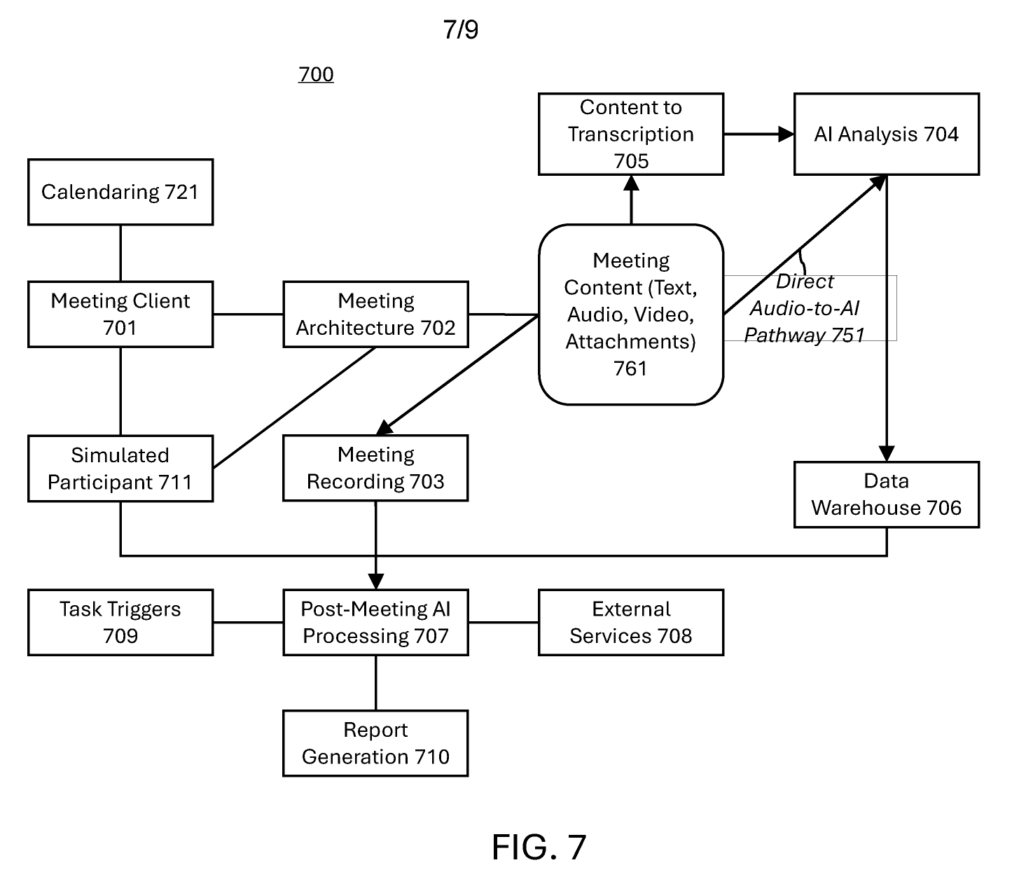

FIG. 7 illustrates an example architecture of an AI-enhanced virtual meeting system.

As shown, the system 700 includes a number of subsystems, as illustrated in the boxes. Subsystems connected by lines represent a two-way communicative coupling, which may also be described herein as a connection or link, that allows for direct or indirect exchange of information, instructions, data, or other content. An arrow indicates that data is transmitted in the direction indicated for one or more steps of any of the procedures described herein. However, an arrow is not intended to limit the direction in which data may flow and otherwise represents a two-way communicative coupling, such as the path that communication between subsystems may take.

A meeting client 701 may comprise a browser-based client, desktop client, mobile client, and/or other user-facing interface of the system 700 through which a participant may interact (e.g., as described herein), including but not limited to joining a meeting, participating in a meeting, managing the scheduling of a meeting, managing acceptance of a meeting, configuring a simulated participant, reviewing post-meeting information, and/or other interactions.

The system 700 may further include calendaring 721. The calendaring 721 may comprise one or more calendar services, scheduling services, invitation-management services, and/or availability-management services communicatively coupled to the meeting client 701 and/or the meeting architecture 702. In some embodiments, the calendaring 721 may store, provide, and/or manage meeting invitations, acceptance status, recurrence information, participant lists, timing data, schedule conflicts, user availability, and/or other scheduling-related data. The calendaring 721 may further support automated acceptance, skipping, subscription, rescheduling, and/or simulated-participant configuration for one or more meetings, including according to one or more rules, preferences, or policies described herein.

The meeting client 701 is connected to a meeting architecture 702, which may represent components of the system necessary to conduct or run core meeting functionality, including but not limited to routing hardware, hosting hardware, and/or other infrastructure. The meeting architecture 702 may additionally or alternatively include one or more media-routing or conference-distribution components configured to receive audio and video streams associated with a meeting session and distribute such streams among users, including human users, simulated participants, and/or system entities participating in the meeting.

The meeting architecture 702 may output meeting content 761. Although not shown, the meeting content 761 may be accessible (e.g., streamed to or retrievable upon request) by the meeting client 701. The meeting content 761 may include any content associated with a meeting session and/or included in any pre-meeting attachment. The meeting content 761 may include, but is not limited to, text, audio, video, and/or attachments (e.g., files).

The meeting content 761 may be provided directly to a meeting recording 703, which may include one or more components for recording and storing the meeting session.

The meeting content 761 may additionally or alternatively be sent to content transcription 705. In one instance, the content transcription 705 may convert the meeting content into text (e.g., transcription and/or descriptions of video or images), regardless of the original modality. In one instance, the content transcription 705 converts audio to text.

The content transcription 705 is connected to AI analysis 704, which may receive transcribed text of the meeting content. The AI analysis 704 may include one or more operations as described herein. The AI analysis 704 may output data to the data warehouse 706. The meeting content 761 may additionally be output directly to the data warehouse 706. The data warehouse 706 may store analyzed data and/or raw data.

Although not shown, the AI analysis 704 may request additional data from the data warehouse 706 during analysis of the transcribed content to enhance generated outputs. For example, if the meeting content includes a question about Project X and information about Project X is present in the data warehouse 706, the AI analysis 704 may request the existing Project X information to determine an answer to the question. Although not shown, the answer to this question, and a record of the inquiry, may be sent back to the data warehouse 706. Although not shown, the answer may be utilized by the simulated participant 711.

Generally, and as further described herein, the AI analysis 704 may utilize one or more AI models, including one or more large language models, to generate insights, recommendations, summaries, or other AI-derived outputs.

In one instance, there may be a direct audio-to-AI pathway 751 that allows for the input of audio, instead of transcribed audio, directly into the AI analysis 704. The direct audio-to-AI pathway 751 may be configured to provide voice input derived from the meeting directly to one or more AI processing resources, thereby enabling an alternative processing path in which speech audio is supplied to an AI model without requiring prior full transcription into text.

The meeting architecture 702 may be connected to a simulated participant 711, which may also be referred to as a personal meeting bot, AI bot, chatbot, virtual representative, or the like, as described herein. The simulated participant 711 comprises one or more service-based or non-human meeting entities represented within the meeting session as participant-like entities that have the ability to interact with the meeting session as configured or necessary.

Although not shown, there may be one or more other service-based or non-human meeting entities represented within the meeting session and/or observing the meeting session that are not configured to interact with the meeting session and/or other users or entities of the meeting. Such non-interactive entities may include, but are not limited to, recorder entities, telephony bridge entities, automated content logic flows, and/or transcription-related entities configured to receive output from the meeting.

The meeting recording 703 may be configured to generate and store one or more persistent meeting content artifacts, including recordings, transcript data, and associated metadata. The meeting recording 703 may be connected to post-meeting AI processing 707, which may be configured to process stored meeting content artifacts after completion of a meeting for additional subsystem processing. The capabilities, functions, and/or tasks of the post-meeting AI processing 707, as compared to the AI analysis 704, may be the same, similar, or different. In one instance, although not shown, these may operate using a shared subsystem. In one instance, this may operate using, at least in part, shared hardware. Post-meeting AI processing 707 may include generating post-meeting outputs such as summaries, action items, reports, and metadata. In one instance, although not shown, one or more of these outputs may be stored in the data warehouse 706.

In some embodiments, the post-meeting AI processing 707 may receive user feedback associated with the performance of the simulated participant 711 during the meeting. The user feedback may include ratings, corrections, approvals, rejections, or other evaluative inputs provided by the user via the meeting client 701 after the meeting has concluded. The post-meeting AI processing 707 may use the received feedback to update one or more model parameters associated with the simulated participant 711, such that subsequent behavior of the simulated participant 711 in future meetings may be adjusted based on the feedback received.

The post-meeting AI processing 707 is communicatively coupled to external services 708. The external services 708 may be configured to execute one or more downstream actions involving external systems based on outputs of the post-meeting AI processing 707. Such downstream actions may include updating a customer relationship management record, storing meeting notes in a vendor-operated external system, initiating automated workflows, and/or generating reports. In one embodiment, the external services 708 may include or communicate with task triggers 709 and/or report generation 710. The task triggers 709 may be configured to initiate one or more downstream tasks, reminders, approvals, assignments, communications, or workflow events based on post-meeting outputs. The report generation 710 may be configured to generate one or more summaries, analytics reports, status reports, compliance reports, or other post-meeting deliverables for storage, display, transmission, and/or further processing.

Although not shown, the system 700 may further include a meeting automation configuration. The meeting automation configuration may be configured to store and/or apply rules, preferences, or policies defining automated actions to be performed in connection with one or more meetings (e.g., handling of post-processing AI, handling of real-time AI analysis, permissions and operations of the simulated participant 711, etc.). The meeting automation configuration may be accessible from the meeting client 701.

In operation, a user may use the meeting client 701 to accept a meeting invitation and to configure a simulated participant 711 for that meeting. In one instance, the acceptance and configuration of a simulated participant 711 may itself be a pre-configured automation. For example, any meeting regarding Project X Weekly Coordination and Status Reporting may be automatically accepted (e.g., regardless of availability in a schedule, since simulated participation may be used), and simulated participant instructions may be pre-written for those specific types of meetings. For example, a meeting sent by, or including, a specific user or set of users, or user type, may be automatically accepted (e.g., regardless of availability in a schedule), and simulated participant instructions may be pre-written for those specific types of meetings.

In one case, when task A is discussed at the meeting, the system may retrieve the status of task A and interact during the meeting session to output the retrieved information. In one case, if a question is asked that relates to the user associated with the simulated participant 711, the system may send a message, email, or phone call to the user for follow-up during the meeting, such that the user can either join the meeting and/or provide an answer to the simulated participant 711, which can then relay the answer to participants of the meeting.

A scenario where one or more of the techniques described herein may be helpful is when a person has a doctor’s appointment and a meeting scheduled at the same time, such that the person is unable to attend the meeting. During the meeting that the person cannot attend, the simulated participant 711 may assist in enabling limited interaction or non-interaction on behalf of the person. A scenario where one or more of the techniques described herein may be helpful is when a person has at least two meetings scheduled at the same time, such that the person is unable to attend both meetings. During the meeting that the person cannot attend, the simulated participant 711 may assist in enabling limited interaction or non-interaction on behalf of the person.

The simulated participant 711 may be configured to interact with the meeting session in one or more ways. The simulated participant 711 may be configured to output text into a chat during the meeting session. The simulated participant 711 may be configured to output audio (e.g., text-to-audio output generated by an AI and/or direct AI-to-audio or AI-to-video output pathways). In some embodiments, the simulated participant 711 may further be configured to provide a summary, ask one or more questions, respond to one or more prompts, request clarification, surface one or more issues to the user, and/or otherwise participate in the meeting session according to stored instructions, permissions, or policies.

In some embodiments, a user may be permitted to subscribe to a meeting without requiring the user to directly join the meeting session via the meeting client 701. Such a subscription may cause the system 700 to treat the user as represented within the meeting session by the simulated participant 711 and/or by another participant-like representation associated with the user. In one instance, the subscription may be received through the calendaring 721 and may be stored as part of invitation acceptance data, participant-state data, and/or meeting automation configuration data. The subscription may indicate that, although the user is not personally present in the meeting session, the user is to be treated as an intended audience member for one or more purposes, including meeting interaction, content tailoring, permissions handling, post-meeting distribution, and/or access determination.

In some embodiments, the represented state of the user may be made visible to one or more other participants of the meeting session. For example, the meeting architecture 702 and/or meeting client 701 may cause display of a visual indication that the user is represented in the meeting by the simulated participant 711. Such visual indication may include, but is not limited to, a name entry, icon, avatar, image, badge, status indicator, participant tile, or other participant-like embodiment. In one instance, the represented state may be shown in a participant list or gallery view in a manner that indicates to other participants that the represented user is effectively present for purposes of audience composition. In this manner, the system 700 may influence how participants communicate during the meeting session by making clear that the represented user is part of the audience to whom statements are being made. Because other participants can see that the absent user is represented, they may direct comments, questions, or information toward the represented user, knowing that such content will reach the absent user through the meeting platform's delivery mechanisms. For example, a participant may address remarks to the represented user by name, raise topics known to be of interest to the represented user, or provide updates intended for the represented user's benefit, with the understanding that the meeting platform will ensure such content is captured and delivered. In this manner, the represented state may actively influence participant behavior and communication patterns during the meeting session, rather than serving solely as a passive indicator.

In some embodiments, the represented state may be utilized to control, modify, and/or justify downstream sharing of meeting content 761 and post-meeting outputs. In one instance, because the user was represented in the meeting session by the simulated participant 711 or other participant-like representation, the system 700 may determine that one or more meeting artifacts may be automatically shared with the user after the meeting. Such artifacts may include, but are not limited to, meeting recording data from meeting recording 703, transcript data from content transcription 705, outputs of AI analysis 704, outputs of post-meeting AI processing 707, attachments, chat content, reports, summaries, action items, metadata, and/or other meeting-derived materials. In one instance, such sharing may occur automatically without requiring another participant to manually select the user for distribution of such materials. In one instance, the represented state may distinguish the user from a non-attendee who was neither present nor represented, such that different post-meeting access rights, dissemination rights, and/or follow-up operations may be applied.

In some embodiments, the simulated participant 711 may operate as more than a passive recipient or placeholder. For example, the simulated participant 711 may be configured with user-specific knowledge, preferences, instructions, policies, permissions, and/or contextual data such that the simulated participant 711 can participate in the meeting session on behalf of the user. In one instance, the simulated participant 711 may receive, prior to the meeting, one or more user positions, constraints, priorities, or instructions describing how the user wishes to be represented. Such instructions may include substantive positions regarding a topic under discussion, approval conditions, negotiation constraints, escalation preferences, or other guidance. During the meeting session, the simulated participant 711 may utilize such information to respond to questions, provide project or task status, communicate the user’s position, request clarification, and/or otherwise interact in a manner intended to represent the user.

In one embodiment, the AI analysis 704 and/or data warehouse 706 may support substantive participation by the simulated participant 711 by retrieving and providing information relevant to the represented user. For example, if another participant asks about the status of a project, task, or workstream associated with the represented user, the AI analysis 704 may obtain relevant information from the data warehouse 706 and provide a response through the simulated participant 711. In one instance, the information may include project status data, prior meeting data, user-authored materials, task records, communications, business records, and/or other enterprise data accessible to the system 700. In this manner, the simulated participant 711 may provide an informed response on behalf of the represented user, thereby enabling bidirectional participation rather than merely passive post-meeting review.

In some embodiments, the degree of representation may vary across implementations. In one instance, the representation may be non-interactive and may comprise a minimal participant embodiment that includes the user's name, avatar, profile image, and/or a visual status indicator such as a "subscribed" or "represented" badge, label, or icon, displayed in a participant list, gallery view, participant tile, or other area of the meeting interface visible to other participants. In this non-interactive embodiment, no AI bot, chatbot, simulated participant, or automated agent is instantiated or active. The non-interactive representation may serve as an audience-designation indicator that informs other participants that the absent user is part of the meeting's intended audience and that post-meeting sharing of meeting materials to the user is authorized or expected. This minimal, non-interactive approach may be a complete and standalone embodiment of the subscribe-represent-deliver workflow, as described herein, because the one techniques discloses herein is the ability of a user to subscribe to a meeting, be visibly represented as part of the meeting's audience, and receive automatic delivery of meeting materials, independent of whether any AI-driven or interactive capabilities are associated with the representation. In another instance, the representation may be partially interactive, such as by providing limited chat responses, surfacing stored instructions, or answering certain classes of questions. For example, in a partially interactive embodiment, a participant in the meeting may ask whether the absent user is joining, and the representation may respond conversationally, such as: "John couldn't make it today, but I'm here to take notes for him. He asked me to make sure we cover the budget topic. I will forward your messages to him." In this manner, the partially interactive representation may acknowledge the absent user's status, relay one or more topics or instructions provided by the absent user prior to the meeting, and offer limited assistance to other participants, without requiring the full AI-driven capabilities of a more fully interactive simulated participant. In another instance, the representation may be more fully interactive, including generation of text output, audio output, or other meeting contributions based on real-time meeting content, retrieved contextual data, and user-specific instructions. Accordingly, the simulated participant 711 may range from a lightweight participant embodiment to a more capable AI-driven virtual representative.

In some embodiments, the system 700 may apply permissions and confidentiality handling based on whether a user is directly present, represented by the simulated participant 711, or absent without representation. For example, because participants in a meeting may tailor their speech and disclosed information based on the audience present, the represented state may function as a signal to participants and/or to the system 700 that the represented user is within the contemplated audience for at least a defined scope of meeting content. In one instance, this may affect automated sharing, access-control decisions, storage associations in the data warehouse 706, and/or the generation of post-meeting outputs. In one instance, the represented state may be limited by policy, such that certain classes of confidential information, restricted materials, or protected discussions are not provided to the represented user unless one or more additional conditions are satisfied.

In some embodiments, configuration of represented attendance may be performed in advance through the meeting client 701 and/or calendaring 721. For example, a user may accept a meeting invitation in a represented-attendance mode, may configure whether the simulated participant 711 is non-interactive or interactive, may define one or more participation instructions, and/or may specify what categories of content the simulated participant 711 is permitted to receive, disclose, or act upon. In one instance, such configuration may be automated according to meeting type, organizer identity, participant identity, subject matter, scheduling conflict, user availability, or one or more predefined rules. Thus, a user may be treated as present for selected meetings despite not directly joining those meetings, while still allowing the system 700 to control participation behavior and post-meeting dissemination in a structured manner.

In some cases, the platform/system described herein may have a Customer Interaction Data Platform (CIDP). This may be additional to, work with, be incorporated with, or in alternative to one or more subsystems described herein (e.g., data warehouse). The CIDP may be a unified, AI-powered solution designed to deliver a comprehensive, 360-degree view of customer interactions across all channels, including voice, chat, email, and/or social media. What differentiates CIDP is its ability to integrate real-time interaction data seamlessly with customer profiles, enabling smarter and more personalized customer experiences throughout their journey. Central to CIDP is its Unified Interaction and Profile Data Layer, which combines live communication data such as calls and chats with customer relationship management (CRM) information and purchase histories into a single, dynamic layer. This effectively eliminates data silos between different channels and sources.

The platform's streaming data architecture supports real-time insights, providing valuable information during active interactions. This capability powers advanced features like live sentiment analysis, intent detection, and next-best-action recommendations. Additionally, CIDP ensures cross-channel context persistence, enabling agents and AI systems to retain full interaction context across different channels and sessions, resulting in more informed and efficient interactions.

The CIDP may incorporate embedded generative AI to automate interaction summarization, extract customer intent, and automatically populate records, significantly reducing agent workload and enhancing accuracy. Further, the platform offers robust customer journey intelligence tools that map and analyze end-to-end customer journeys, leveraging interaction metadata and customer outcomes to drive continuous improvements. Additionally, CIDP features an open and extensible data fabric with open APIs and pre-built connectors to various CRMs, helpdesks, and analytics platforms, allowing easy adaptation within diverse technology ecosystems without vendor lock-in.

In one implementation, the CIDP is integrated with routing management components in a detailed workflow. At its core, the CIDP centralizes customer interaction data from various sources such as CRM databases, non-CRM data including transcriptions from chats, emails, texts, and QMSA topics. This collected data may be funneled through the CIDP API Facade, a central interface managing the data flows and integrations.

The CIDP may interact closely with the 8x8 Insights Data Warehouse, which stores contextual insights and metadata. Examples of the insights stored include escalation information, customer health scores, attention requirements, customer sentiments, product support details, sales data, customer success management (CSM), and product/add-on information.

The CIDP platform may have an "Insight Collector," a component that interfaces with a "Workspace Request Handler" and a "Front-end Data Feed" responsible for aggregating and combining insights. This integration allows real-time AI/ML-driven insights to flow smoothly through the CIDP system.

In one instance, connected to the CIDP infrastructure is a Partner Ecosystem comprising external entities labeled as Partner A and Partner B, demonstrating the openness and extensibility of the platform for additional integrations or service enrichments.

The "Workspace & Routing" section may provide an operational view, displaying user-customized insights such as escalated cases, topics most likely to be escalated, frequent customer concerns, and a customer health score. Routing Management Components utilize AI/ML to manage and route communications intelligently based on priorities indicated by cases needing attention, escalation, or containing negative sentiment.

The Workspace & Routing section may present concrete operational metrics, including counts of escalations, cases needing attention, and negative sentiment cases. For example, a specific illustrative case may detail a customer's dropped call event, discussed topics, and other key communication elements.

In one implementation, the CIDP correlates data sources to destinations. The CIDP may operate as a unified, AI-powered central hub, integrating various data sources and distributing insights to multiple destination services within 8x8 Work.

Several inbound data sources may feed into the CIDP, showcasing the breadth of information the platform aggregates. These sources include AI vendors, third-party elements, post-interaction surveys, community posts, social media data, CRM systems, historical interactions (8x8), real-time interactions (8x8), recordings and transcriptions (8x8), support logs, and data from Cognigy. The varied nature of these sources demonstrates the platform's ability to integrate structured and unstructured data from internal systems as well as external channels, forming a comprehensive, omni-channel perspective of customer interactions.

The CIDP may feed enriched and consolidated data into multiple destinations—specific services and functionalities within the 8x8 ecosystem. These include 8x8 Engage, Agent Workspace, Supervisor Workspace, CRM integrations, Sales & Account Workspace, Analytics tools, Public API interfaces, Routing and Queuing services, Automation capabilities, Customer 360 dashboards, Journey IQ (customer journey analysis tools), and Orchestration functionalities. This architecture underscores how CIDP translates aggregated insights into actionable intelligence that enhances various customer-facing and internal services, ultimately enabling smarter, more personalized, and contextually aware customer experiences throughout their entire journey.

In some cases, there may be specific segments of documentation, contracts, etc., related to a communications platform that may be leveraged for specific training sources. This data processed by the AI component may provide data insights, feedback, recommendations, contextual reporting and summarizations, etc. These may be tied in and integrated with the other data sources to enable tailored, contextually relevant data to be generated across any business use case. For example, sales/commercial data, such as customer contracts/agreements, training materials, presentations/slide decks, summarizations, deal notes, revenue, tax public-facing filings, etc. For example, customer support/ customer support management, which may include help desk tickets, support website, knowledge-base and articles customer support manager (CSM) documentation, notes, etc., customer call analytics, etc. For example, legal and regulatory, which may include prepared legal documents, documents/templates, product terms and conditions, regulatory/data privacy, data security, IP, procurement and vendor-related intel, etc. For example, marketing, which may include branding and brand guidelines, marketing campaigns, taglines, advertising, website, social media, etc. For example, product & engineering, products, features/functionalities, product roadmap and management, development, integration, open source, feedback, demos & environments, configurations, etc. For example, another data point may be customer profiles.

Additionally/alternatively, there may be data points from third-party integrations and public-facing documentation: As noted herein, data may include integrations from third-party vendors such as partners integrating with a communication platform. Further, there may also data from public-facing documentation made publicly available (e.g., via the web, web crawling/indexing), and/or integrated AI tools (e.g., ChatGPT, Gemini, Claude, etc.).

In some cases, there may be AI model internal/external training for an AI component of a platform, such as described herein (e.g., 8x8 hosted or 8x8-specific instance with AI/ML provider) rather than a shared AI learning model. In such cases, data may be used for training, but not shared externally. However, this disclosure is not intended to be limited to this instance.

For purposes of the AI component, data may be collected, indexed, analyzed, leveraged, augmented, etc., from any of the data endpoints described herein. The AI component may create a live, ever-growing, extensible ecosystem that provides unique practical applications (in cloud-based communications) that are made possible by leveraging the unique big data of the 8x8 communications platform. For training purposes, it is further beneficial to create targeted data sets for specific use cases (e.g., user-related, service-related, segment/vertical-related), collecting data points and metadata that can be leveraged to generate data insights, importantly including those that inferred (and/or predictive) which go beyond what may be indicated in a specific communication (i.e., the customer says one thing but means another).

Training AI/ML may be possible the data points (e.g., described herein) through various host applications/services (e.g., pertaining to a software communications platform). For instance, the application of trained AI/ML processing (e.g., one or more trained machine learning models) may be adapted to evaluate data sources integrated into an exemplary software platform (e.g., software communications platform such as 8x8 Work®), omni-channel orchestration of data points that include native data sources as well integrated third-party endpoints (e.g., third-party integrations including CRM tools). Contextual data can be derived from any data point individually or in aggregation, including historical signal data or current signal data (e.g., an ongoing communication such as an electronic meeting). For example, historical signal data collected using a software communications platform, including from prior user communications, can be combined with current user-specific signal data, device-specific signal data, etc., prior to, during or after an electronic communication (e.g., chatbot interaction), to generate and surface contextually relevant data insights for a user (e.g., agent assisting a customer and/or in different omni-channel communication experiences across a software communications platform). This unique and comprehensive analysis of big data managed through a software communications platform enables the provision of rich and contextually relevant data insights tailored for a specific purpose (e.g., enhance user communication and abilities of agents in communications with customers) and further contextual data that can be leveraged to improve back-end data processing and real-time (near real-time) operation of applications/services including GUI features/functionalities presented to users of application/services, software communications platforms, etc. Exemplary signal data analysis can further be utilized to yield determinations as to how (and/or when) to generate updated analytics (in real-time or near real-time) and/or reporting, as well as when and how often to present data insights and/or suggestions. For example, it is important to properly evaluate a state of communication and identify contextually relevant data within an ongoing communication (e.g., dependent on user’s sentiment, topic of conversation, content being presented, user attendance, etc.) relative to historical data and/or predicted patterns of users, which may help to determine not only the correct data to surface but when that data would be most beneficial to users. In further examples, signal data can be analyzed to determine the next steps or actions to be performed to continue communication and user engagement across a plurality of communication channels of a software communications platform (e.g., omni-channel communication experience). As non-limiting examples, this may include automatically taking action to include other users in a communication, sentiment analysis, summarization, setting reminders, follow-up meetings, etc. communicating contextual data representations to agents, support staff pertaining to customer interactions, feedback, etc. Non-limiting examples of signal data that may be collected and analyzed includes but is not limited to: device-specific signal data collected from operation of one or more user computing devices; user-specific signal data collected from specific tenants/user-accounts with respect to access to any of: devices, login to a distributed software platform, applications, services, etc.; application-specific data collected from usage of applications/services and associated endpoints (including third-party endpoints integrated within a software platform), data collected from disparate software platforms that provide disparate types of access characteristics; data collected from data flow architecture including integrated bots in a software communications platform, or a combination thereof. Analysis of such types of signal data in an aggregate manner may be useful in helping generate contextually relevant determinations, data insights, etc. Analysis of exemplary signal data may comprise identifying correlations and relationships between different types of signal data specific to user usage of one or more software data platforms (e.g., software communications platforms) whether the target users are developers/engineers, end users/customers, where telemetric analysis may be applied to generate determinations with respect to a contextual state of any type of user activity with respect to different host application/services and associated endpoints at any point in time (historic, current, or predictive of future). Analysis of signal data, including user-specific signal data, should occur in compliance with user privacy regulations and policies.

In some examples, one or more components are configured to manage application of one or more AI models to enhance processing described in the present disclosure. Trained AI processing is applicable to aid any type of determinative or predictive processing including specific processing operations described with respect to determinations, classification ranking/scoring and relevance ranking/scoring. An exemplary component for implementation trained AI processing may manage AI modeling including the creation, training, application, and updating of AI, ML modeling. Trained AI processing may be adapted to execute specific determinations described herein including those for analyzing specific data and data sources of a software data platform (e.g., a software communications platform) and/or generating insights for management of data flows, GUI feature functionality, or data augmentation. For instance, an AI model may be specifically trained and adapted for execution of processing operations pertaining to analyzing features and functionality of a software communications platform including those non-limiting examples described herein. Non-limiting examples of AI implementation including but are not limited to: analyzing data (and metadata) associated with one or more software platforms including third-party integrations of features/functionalities; analyzing data of past, current or scheduled communications, among other examples.

In one example, trained AI processing comprises a hybrid AI model (e.g., hybrid machine learning model, neural network model) that is adapted and trained to execute a plurality of processing operations described in the present disclosure. In alternative examples, trained AI processing comprises a collective application of a plurality of trained AI models (e.g., 3 trained AI models) that are separately trained and managed to execute processing described herein. In alternative examples, the present disclosure extends to integrating third-party AI modeling and further adapting and customizing said AI modeling to work with specific data and data sources of an exemplary software platform. For example, a third-party AI model may be adapted to work within a software communications platform including data, data sources, and integrations (e.g., APIs, web hooks, etc.) related to features and functionality provided (or extending capabilities) of a software communications platform. In examples where a plurality of independently trained and managed AI models is implemented, downstream processing efficiency may be improved by an ordered application of trained AI models where processing results from earlier applied AI models can be propagated to subsequently applied AI models. For example, a trained AI model may evaluate accesses, seeds, pinecones, indicators, external influences, weighting and the like, and derive data correlations to improve processing and efficiency. This may be utilized to adjust weighting and/or assessed risk levels based on the evaluations.

Non-limiting examples of supervised learning that may be applied comprise but are not limited to: nearest neighbor processing; naive Bayes classification processing; decision trees; linear regression; support vector machines (SVM) neural networks (e.g., convolutional neural network (CNN) or recurrent neural network (RNN)); and transformers, among other examples. Non-limiting examples of unsupervised learning that may be applied comprise but are not limited to: application of clustering processing including k-means for clustering problems, hierarchical clustering, mixture modeling, etc.; application of association rule learning; application of latent variable modeling; anomaly detection; and neural network processing, among other examples. Non-limiting examples of semi-supervised learning that may be applied comprise but are not limited to: assumption determination processing; generative modeling; low-density separation processing and graph-based method processing, among other examples. Non-limiting examples of reinforcement learning that may be applied comprise but are not limited to: value-based processing; policy-based processing; and model-based processing, among other examples. Furthermore, a component for implementation of trained AI processing may be configured to apply a ranker to generate relevance scoring to assist with any processing determinations with respect to any relevance analysis, such as that described herein. Scoring for relevance (or importance) ranking may be based on individual relevance scoring metrics described herein or an aggregation of said scoring metrics. In some examples where multiple relevance scoring metrics are utilized, a weighting may be applied that prioritizes one relevance scoring metric over another depending on the signal data collected and the specific determination being generated. Results of a relevance analysis may be finalized according to developer specifications. This may comprise a threshold analysis of results, where a threshold relevance score may be comparatively evaluated with one or more relevance scoring metrics generated from application of trained AI/ML processing.

Further, aspects may integrate AI/ML modeling to correlate large volumes of data in a contextually relevant manner. This can be used not only for generation (and adaptation) of scoring for types of data to surface but also generation of decision points (e.g., alerting, access control, next steps, omni-channel engagement) as well as generation of data insights/suggestions, reporting, generation of knowledge base, support content, data processing flow configuration recommendations. In addition to broad applicability, approaches according to the present disclosure can be implemented as a scalable solution (e.g., a solution for a company in several different use cases are built (such as department-specific or user group-specific) to more effectively manage a software platform (e.g. communications software platform).

As an example, one or more ML/AI models may be generated, trained and adapted to analyze context of chatbot interactions, for example, to identify sticking points and issues that may persist in a current configuration and data processing flow in an exemplary data orchestration layer. For instance, one integrated chatbot may be configured to manage topics of travel while another chatbot may be configured to handle sentiment analysis. Through analyzing data points of a conversation between a user and service, it can be detected that a user is frustrated with the first chatbot (topics of travel) in that the chatbot wasn’t properly assisted with booking of dinner reservations in a selected travel location. This data point, among others, can be determined and fed back to the developers to consider reviewing and modifying the data processing flow, including potential integration of additional bots into an exemplary data orchestration layer, to resolve potential points of frustration for an end user.

In further examples, the AI/ML modeling (or separate additional modeling combined therewith can be adapted) may further analyze additional endpoints of a software communications platform to provide richer, contextual, and cross-functional insights for management of data processing (e.g., in data orchestration layers) or user/customer management. For instance, AI modeling may be applied to analyze a chatbot query and conversation further in the context of other data points across a software communications platform (e.g., chat, messaging, emails, meetings, recordings, CRM data, etc.) to generate persistent data insights application cross-platform to better manage an overall user experience. Continuing the above example re: dinner reservations, patterns of analysis by the adapted AI/ML modeling may learn that this is the third time that the same user has had an issue with this chat, which can be information passed on to customer agents, success managers, etc. to help improve an overall customer experience. In further examples, insights may be generated from such contextual analysis and/or suggestions for remediation which can be presented through a GUI to an agent or user. Moreover, suggested messages may even be generated and surfaced to end users directly (e.g., we know you have had multiple issues with this chatbot, and it must be frustrating, here is how we can address). This can further utilize and expand omni-channel communication capabilities of a software communications platform to build a truly customized and personalized user experience. Additionally, it provides an avenue for end users (e.g., customers) to provide feedback directly on specific features/functionalities (including pain points) that can then be directed to the engineers and product managers for re-evaluation of data flow and data processing (e.g., via data orchestration layers).

In additional examples, AI/ML modeling may be built, trained, and adapted to manage insight generation and layers of abstraction including ranking and relevance. For instance, contextual analysis of data interactions relative to the plurality of data endpoints for an exemplary software communications platform can selectively generate insights specific to interested parties such as product/engineering, data insights that are specific to end users, and data insights, that are specific to others including third-party vendors (e.g., who may integrate with a software communications platform). Generated insights can be ranked for relevance and propagated accordingly for one or more interested parties, for example, aligning with organizational specifications. Say that an insight was generated for product/engineering to address a potential pain point with a bot data processing flow that has relevance to a third-party vendor integration (e.g., for that chatbot). It is likely that the product/engineering team may want to sync with that third-party vendor to address. Depending on their organizational desires, AI/ML modeling can be used to generate a corresponding data insight for that third-party vendor, associated with the data insight generated for product/engineering, which can foster efficiency in issue communication and remediation in a processing data flow. In other examples, engineering may wish leverage such data insights to automatically raise a support ticket (internally and/or via a third-party vendor) to address data integration issues, among other possible actions.

In some embodiments, a method of managing participation in a meeting using a meeting platform may comprise receiving, by one or more processors of the meeting platform, from a first user device associated with a first user, a subscription indication for a meeting. The subscription indication may indicate that the first user will not directly join the meeting but wishes to remain connected to the meeting as part of the meeting's intended audience. In response to the subscription indication, the meeting platform may cause a representation associated with the first user to be displayed within the meeting to one or more other participants of the meeting. The representation may comprise at least a visual indication in a participant-visible area of a meeting interface that the first user is represented in the meeting, such that the one or more other participants are informed that the first user is part of the audience for the meeting. Upon conclusion of the meeting or during the meeting, the meeting platform may automatically deliver one or more meeting materials to the first user based on the first user's represented state. The represented state may distinguish the first user from a non-attendee who did not subscribe and who is not represented in the meeting.

In some embodiments, the representation may comprise a non-interactive implementation where the first user's name, avatar, or profile image and a status indicator displayed in a participant list or gallery view, without any AI bot, chatbot, or automated agent being instantiated or active within the meeting. In such an embodiment, the representation may serve as an audience-designation indicator that informs other participants that the first user is part of the meeting's intended audience and that post-meeting delivery of meeting materials to the first user is authorized or expected. The non-interactive embodiment may be a complete and standalone implementation of the subscribe-represent-deliver workflow, independent of any AI-driven or interactive capabilities.

In some embodiments, the representation may comprise a partially interactive automated participant configured to respond to inquiries from the one or more other participants regarding the first user, relay one or more topics or instructions provided by the first user prior to the meeting, and capture notes on behalf of the first user. For example, if another participant asks whether the first user is joining the meeting, the partially interactive automated participant may respond conversationally, such as by indicating that the first user could not attend, that the automated participant is taking notes on the first user's behalf, that the first user requested discussion of a particular topic, and that the automated participant can attempt to answer basic questions on the first user's behalf. The partially interactive automated participant may not require the full AI-driven capabilities of a more fully interactive simulated participant.

In some embodiments, the representation may comprise a fully interactive AI-driven simulated participant configured to actively contribute to the meeting on behalf of the first user based on real-time meeting content, retrieved contextual data, and user-specific instructions. The fully interactive simulated participant may be configured with user-specific knowledge, preferences, instructions, policies, permissions, and/or contextual data such that the simulated participant can respond to questions, provide project or task status, communicate the first user's position, request clarification, and/or otherwise interact in a manner intended to represent the first user during the meeting session.

In some embodiments, the one or more meeting materials automatically delivered to the first user may comprise at least one of a meeting recording, a transcript, an AI-generated summary, action items, follow-up communications, chat content, or attachments shared during the meeting. The automatic delivery may be triggered by the first user's represented state and may occur without requiring another participant to manually select the first user for distribution of such materials.

In some embodiments, the visual indication that the first user is represented in the meeting may cause one or more other participants to direct comments, questions, or information toward the first user during the meeting, knowing that such content will be captured and delivered to the first user through the meeting platform's delivery mechanisms. In this manner, the represented state may actively influence participant behavior and communication patterns during the meeting session, rather than serving solely as a passive indicator of the first user's subscription.

In some embodiments, the subscription indication may be received through a calendar integration, a meeting invitation interface, or a meeting dashboard of the meeting platform. Subscribing may require no configuration of an AI bot or automated participant by the first user. The subscription action may be comparable in simplicity to accepting a meeting invitation and may require no further input from the first user beyond the initial indication of interest in remaining connected to the meeting.

In some embodiments, the meeting platform may apply different post-meeting access rights, dissemination rights, or follow-up operations based on whether a given user was directly present in the meeting, represented in the meeting via subscription, or absent without representation. For example, a user who was directly present may receive full access to all meeting materials. A user who was represented via subscription may receive automatic delivery of meeting materials according to the scope of the subscription and representation configuration. A user who was absent without representation may not receive automatic delivery of meeting materials and may be treated as outside the meeting's intended audience for purposes of content distribution.

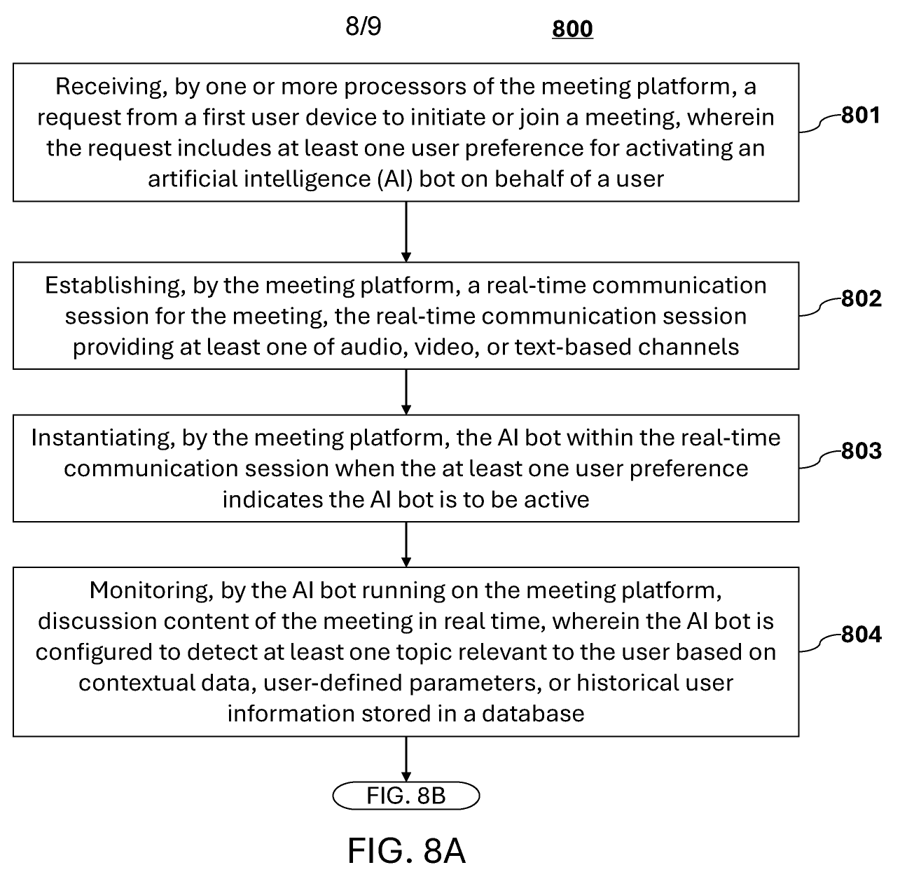

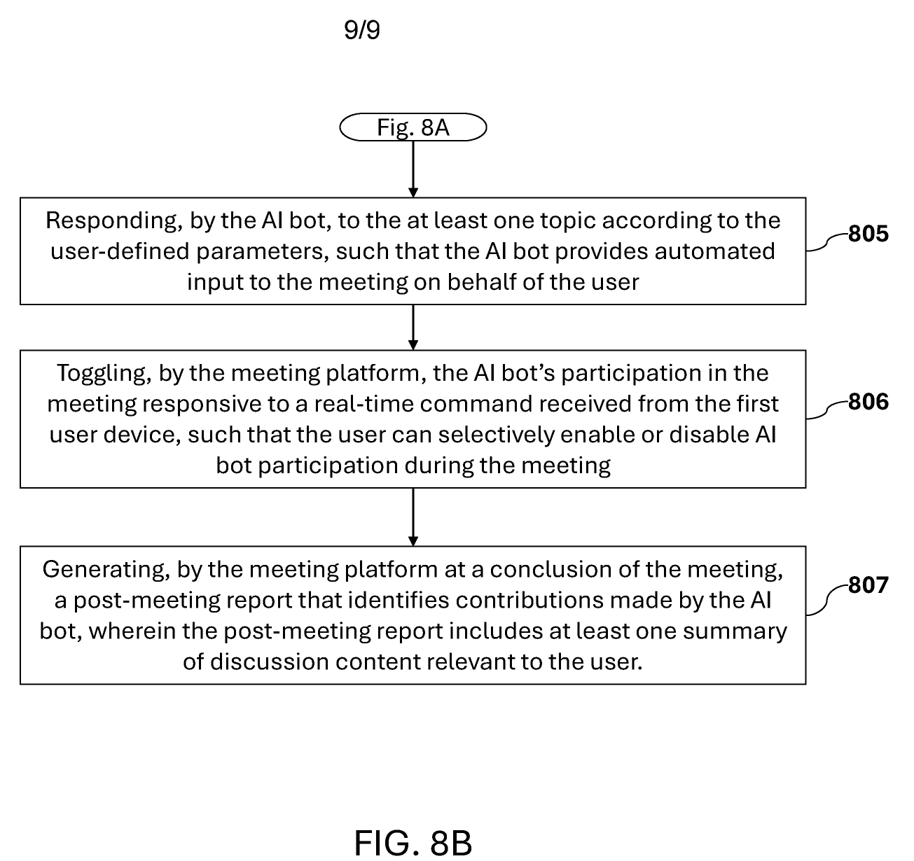

FIG. 8 illustrates an example method 800 of managing a meeting using a meeting platform. At step 801, one or more processors of the meeting platform may receive, from a first user device, a request to initiate or join a meeting, where the request may include one or more user preferences, rules, instructions, and/or configuration settings indicating whether an artificial intelligence (AI) bot is to be activated on behalf of a user. At step 802, the meeting platform may establish a real-time communication session for the meeting, the real-time communication session providing at least one of audio, video, or text-based channels. At step 803, the meeting platform may instantiate the AI bot within the real-time communication session when the at least one user preference indicates that the AI bot is to be active. At step 804, the AI bot running on the meeting platform may monitor discussion content of the meeting in real time, where the AI bot is configured to detect at least one topic relevant to the user based on contextual data, user-defined parameters, and/or historical user information stored in a database. At step 805, the AI bot may respond to the at least one topic according to the user-defined parameters such that the AI bot provides automated input to the meeting on behalf of the user. At step 806, the meeting platform may toggle participation of the AI bot in the meeting responsive to a real-time command received from the first user device, such that the user can selectively enable or disable AI bot participation during the meeting. At step 807, at a conclusion of the meeting, the meeting platform may generate a post-meeting report identifying contributions made by the AI bot, where the post-meeting report includes at least one summary of discussion content relevant to the user.

As described herein, there may be a process comprising of one or more steps, where one or more steps may have their order changes, be optional, simultaneous, and/or omitted depending on a given use case. It is intended that this process may include one or more elements from the embodiments/examples disclosed herein, even though such inclusion may not be explicit.

Although features and elements are described above in particular combinations (e.g., embodiments, methods, examples, etc.), one of ordinary skill in the art will appreciate that each feature or element may be used alone or in any combination with the other features and elements. For example, as disclosed herein there may be a method described in association with a figure for illustrative purposes, and one of ordinary skill in the art will appreciate that one or more features or elements from this method may be used alone or in combination with one or more features from another method described elsewhere. A symbol ‘/’ (e.g., forward slash) may be used herein to represent ‘and/or’, where for example, ‘A/B’ may imply ‘A and/or B’. As used herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’ or indicate that something "does happen" or "may happen". In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a computer, server, communications platform, UE, terminal, base station, network device, phone device, or the like

As described herein, “etc.” may refer to etcetera, which is intended to reference any other like element in a list, or reference some other element disclosed herein. For example, if a list has “a, b, c, etc.” and another list disclosed herein discloses “a, b, c, d, e” then it is intended that the “etc.” may refer to at least “d, e” or “etc.” may generally refer to other letters in the alphabet.

As described herein, "at least one of" may be interchangeable with "one or more of".

As described herein, reference of a configuration may mean that at some point a device may receive a message that includes configuration information. In one instance, the device may provide feedback after having received it. In one instance, the device may request the message. In one instance, the message may be unrequested.

What is claimed is:

1. A method of managing a meeting using a meeting platform, the method comprising:
receiving, by one or more processors of the meeting platform, a request from a first user device to initiate or join a meeting, wherein the request includes at least one user preference for activating an artificial intelligence (AI) bot on behalf of a user;
establishing, by the meeting platform, a real-time communication session for the meeting, the real-time communication session providing at least one of audio, video, or text-based channels;
instantiating, by the meeting platform, the AI bot within the real-time communication session when the at least one user preference indicates the AI bot is to be active;
monitoring, by the AI bot running on the meeting platform, discussion content of the meeting in real time, wherein the AI bot is configured to detect at least one topic relevant to the user based on contextual data, user-defined parameters, or historical user information stored in a database;
responding, by the AI bot, to the at least one topic according to the user-defined parameters, such that the AI bot provides automated input to the meeting on behalf of the user;
toggling, by the meeting platform, the AI bot’s participation in the meeting responsive to a real-time command received from the first user device, such that the user can selectively enable or disable AI bot participation during the meeting; and
generating, by the meeting platform at a conclusion of the meeting, a post-meeting report that identifies contributions made by the AI bot, wherein the post-meeting report includes at least one summary of discussion content relevant to the user.

2. The method of claim 1, further comprising:
receiving, by the meeting platform, feedback from the user regarding the AI bot’s performance during the meeting, and updating model parameters associated with the AI bot based on the received feedback.

3. The method of claim 1, wherein monitoring the discussion content of the meeting comprises:
performing automatic speech recognition or text transcription of at least one communication channel of the real-time communication session;
applying natural language processing algorithms to identify keywords or topics in the transcribed content; and
matching the keywords or topics with user-defined rules or machine-learning classifiers to determine whether the topic is relevant to the user.

4. The method of claim 1, further comprising:
retrieving, by the meeting platform, an AI bot profile that includes domain-specific knowledge, user-specific preferences, or contextual data about the meeting, wherein the AI bot profile is used to customize responses generated by the AI bot.

5. The method of claim 1, further comprising:
distributing, by the meeting platform, the post-meeting report to a plurality of meeting participants, wherein the post-meeting report contains timestamps that link the AI bot’s contributions to corresponding segments of an audio or video recording of the meeting.

6. The method of claim 1, further comprising:
deploying the meeting platform in one of a cloud-based, an on-premises, or a hybrid computing environment, such that resources for meeting management, AI inference, and data storage are allocated based on organizational requirements or usage demands.

7. The method of claim 1, wherein generating the post-meeting report further comprises:
creating, by the meeting platform, an AI-generated summary highlighting discussion items requiring the user’s follow-up, unresolved tasks, and action items assigned to the AI bot or other meeting participants.

8. An apparatus for managing a meeting using a meeting platform, the apparatus comprising:
one or more processors; and
a memory storing instructions that, when executed by the one or more processors, cause the apparatus to:
receive a request from a first user device to initiate or join a meeting, wherein the request includes at least one user preference for activating an artificial intelligence (AI) bot on behalf of a user;
establish a real-time communication session for the meeting, the real-time communication session providing at least one of audio, video, or text-based channels;
instantiate the AI bot within the real-time communication session when the at least one user preference indicates the AI bot is to be active;
monitor, by the AI bot, discussion content of the meeting in real time, wherein the AI bot is configured to detect at least one topic relevant to the user based on contextual data, user-defined parameters, or historical user information stored in a database;
respond, by the AI bot, to the at least one topic according to the user-defined parameters, such that the AI bot provides automated input to the meeting on behalf of the user;
toggle the AI bot’s participation in the meeting responsive to a real-time command received from the first user device, such that the user can selectively enable or disable AI bot participation during the meeting; and
generate, at a conclusion of the meeting, a post-meeting report that identifies contributions made by the AI bot, wherein the post-meeting report includes at least one summary of discussion content relevant to the user.

9. The apparatus of claim 8, wherein the instructions further cause the apparatus to:
receive feedback from the user regarding the AI bot’s performance during the meeting; and
update model parameters associated with the AI bot based on the received feedback.

10. The apparatus of claim 8, wherein, to monitor the discussion content of the meeting, the instructions cause the apparatus to:
perform automatic speech recognition or text transcription of at least one communication channel of the real-time communication session;
apply natural language processing algorithms to identify keywords or topics in the transcribed content; and
match the keywords or topics with user-defined rules or machine-learning classifiers to determine whether the topic is relevant to the user.

11. The apparatus of claim 8, wherein the instructions further cause the apparatus to:
retrieve an AI bot profile that includes domain-specific knowledge, user-specific preferences, or contextual data about the meeting, wherein the AI bot profile is used to customize responses generated by the AI bot.

12. The apparatus of claim 8, wherein the instructions further cause the apparatus to:
distribute the post-meeting report to a plurality of meeting participants, wherein the post-meeting report contains timestamps that link the AI bot’s contributions to corresponding segments of an audio or video recording of the meeting.

13. The apparatus of claim 8, wherein the apparatus is deployed in one of a cloud-based environment, an on-premises environment, or a hybrid computing environment, such that resources for meeting management, AI inference, and data storage are allocated based on organizational requirements or usage demands.

14. The apparatus of claim 8, wherein the generating the post-meeting report further causes the apparatus
create, by the meeting platform, an AI-generated summary highlighting discussion items requiring the user’s follow-up, unresolved tasks, and action items assigned to the AI bot or other meeting participants.
